(19) United States
(12) Patent Application Publication
(10) Pub. No.: US 2024/0211647 A1
(43) Pub. Date: Jun. 27, 2024

(54) Systems and Methods for Training and Simulation of Autonomous Driving Systems

(71) Applicant: Ansys, Inc., Canonsburg, PA (US)

(72) Inventors: Anupam Ashish, Hallbergmoos (DE); Evren Yortucboylu, Pucheim (DE)

(21) Appl. No.: 18/085,665

(22) Filed: Dec. 21, 2022

(51) Int. Cl. G06F 30/15; G05D 1/00; G06F 18/2137

(52) U.S. Cl. CPC G06F 30/15; G05D 1/0088; G06F 18/2137; G06F 2123/02

(57) ABSTRACT

Systems and methods are provided for simulating operation of an autonomous vehicle control system. Three dimensional multi-sensor data associated with a plurality of real-world drives in a sensor equipped vehicle is accessed. For a particular drive, the three dimensional multi-sensor data is reduced to a time series of two dimensional representations. The time series of two dimensional representations is classified into a sequence of states, where the sequence of states associated with the particular drive and the three dimensional multi-sensor data are stored in a computer-readable medium as a scenario. A query is received that identifies a state criteria, and the scenario is accessed based on the sequence of states matching the state criteria of the query. The three dimensional multi-sensor data of the scenario is provided to an autonomous driving system to simulate behavior of the autonomous driving system when faced with the scenario.

### FIELD

This disclosure is related generally to autonomous vehicle driving systems and more particularly to efficient training and simulation of autonomous vehicle driving systems.

### BACKGROUND

Sensor equipped vehicles collect data associated with many millions of miles driven per year. This data is integral to proper training and testing of autonomous vehicle systems. Autonomous vehicle AI systems may be trained using collected data associated with driving scenarios of interest (e.g., a vehicle in wet conditions approaching a traffic jam) and corresponding human driver decisions that successfully, or unsuccessfully, navigated the situation. The autonomous vehicle AI system may then mimic that good driving behavior in the future when it determines that it is facing a similar situation. Driving scenario data may also be useful in testing/verifying an autonomous vehicle system to confirm that it behaves correctly when encountering different scenarios of interest. Autonomous vehicle systems can be trained/tested more efficiently when they are provided scenarios that match training/testing needs.

### SUMMARY

Systems and methods are provided for simulating operation of an autonomous vehicle control system. Three dimensional multi-sensor data associated with a plurality of real-world drives in a sensor equipped vehicle is accessed. For a particular drive, the three dimensional multi-sensor data is reduced to a time series of two dimensional representations. The time series of two dimensional representations is classified into a sequence of states, where the sequence of states associated with the particular drive and the three dimensional multi-sensor data are stored in a computer-readable medium as a scenario. A query is received that identifies a state criteria, and the scenario is accessed based on the sequence of states matching the state criteria of the query. The three dimensional multi-sensor data of the scenario is provided to an autonomous driving system to simulate behavior of the autonomous driving system when faced with the scenario.

As another example, a method of training an autonomous vehicle control system model includes accessing three dimensional multi-sensor data associated with a plurality of real-world drives in a sensor equipped vehicle. For a particular drive, the three dimensional multi-sensor data is reduced to a time series of two dimensional representations. The time series of two dimensional representations is classified into a sequence of states, where the sequence of states associated with the particular drive and the three dimensional multi-sensor data are stored in a computer-readable medium as a scenario. A query is received that identifies a state criteria, and the scenario is accessed based on the sequence of states matching the state criteria of the query. The three dimensional multi-sensor data of the scenario is provided to an autonomous driving system to train an artificial intelligence model of the autonomous driving system, where three dimensional multi-sensor data of other scenarios that match the state criteria of the query are also provided to the autonomous driving system for training.

### DESCRIPTION OF DRAWINGS

FIG. 1 is a diagram depicting a scenario classification engine and training/simulation module.

FIG. 2 is a diagram depicting additional detail of an example scenario classification engine and training/simulation module.

FIG. 3 is a diagram depicting example details of operations performed by a sensor data reduction and state detection module.

FIG. 4 is a diagram depicting example reduction of three dimensional sensor data to a two dimensional representation.

FIG. 5 is a diagram depicting an example intermediate step in transitioning from the lidar representation to the time series of two dimensional representations.

FIG. 6 illustrates example data structures for converting three dimensional sensor data to a two dimensional representation.

FIG. 7 illustrates example data structures for converting three dimensional sensor data to a two dimensional representation for a detected object.

FIG. 8 is a diagram depicting interpolation of lane indicating road marking data and vehicle location data.

FIG. 9 is a diagram depicting correction of location data of an ego vehicle.

FIG. 10 is a diagram depicting a reduction of a point in time for which three dimensional multi-sensor data is reduced into one two dimensional representation.

FIG. 11 is a diagram depicting a visualization of a time series of two dimensional representation.

FIG. 12 is a diagram depicting a tracking of relative positions of first and second vehicles relative to an ego vehicle in a two dimensional representation.

FIG. 13 is a diagram depicting classification of time series of two dimensional representations into a sequence of states.

FIG. 14 depicts a portion of a finite state machine for classifying a time series of two dimensional representations into a sequence of states.

FIG. 15 is a diagram depicting monitoring of a target vehicle in front of the ego vehicle over time to identify a velocity pattern of that target vehicle.

FIG. 16 depicts detection of additional vehicle conditions of interest that may be included in a scenario data structure for use in scenario searches.

FIG. 17 is a diagram depicting a scenario search engine and an example scenario data structure.

FIG. 18 is a diagram depicting an example state search criteria and a matching sequence of state.

FIG. 19 is a diagram depicting a graphical user interface for identifying the state criteria of a query and additional non-state criteria.

FIG. 20 is a diagram depicting a visualization of a search matching.

FIG. 21 depicts a map indicating a concentration of recorded drives in urban areas and areas where highways intersect.

FIG. 22 is a diagram depicting a load balancer for distributing scenarios for processing.

FIG. 23 is a diagram depicting augmenting scenario starting locations so as to perform load balancing.

FIGS. 24-26 depict example scenario states that may be present in a sequence of states tracked by a scenario data structure.

FIG. 27 is a flow diagram depicting for simulating operation of an autonomous vehicle control system.

FIG. 28 is a flow diagram depicting a method of training an autonomous vehicle control system model.

FIGS. 29A, 29B, and 29C depict example systems for implementing the approaches described herein for simulating operation of an autonomous vehicle control sensor.

### DETAILED DESCRIPTION

Autonomous driving systems are typically trained based on significant amounts of training data that is collected during operation of real world vehicles. Most real world drives are mundane and uneventful. Autonomous driving systems are often overtrained on uneventful data, while those same systems may be undertrained on less common scenarios. Thus, in operation, those driving systems tend to perform very well operating in routine situations, but may struggle when faced with less frequently occurring off-nominal situations (e.g., a vehicle travelling 50+ on a highway approaching a traffic jam on a sharply curved road). The performance of those driving systems may be improved by providing a greater number of training scenarios representative of those anomaly conditions. The ability of those driving systems to handle those difficult situations can then be tested by simulating the driving system's reaction to similar driving conditions.

While millions of miles of drive data (e.g., sensor and other data recorded by a sensor-equipped vehicles) are recorded each month for use in training and verifying autonomous driving systems, that data tends to be cumbersome for identifying driving scenarios of interest. Multiple sensors on vehicles are typically capturing several (e.g., 10 s, 100 s, 1000 s) data points per second over many hours of driving time. If the driver is not flagging or otherwise annotating driving events as they occur, an activity that might have safety implications of its own, identifying driving scenarios of interest for training and simulation after the fact may be very difficult. Sensor data that captures the “ground truth” that a vehicle experiences during a drive (e.g., data from lidar; radar; cameras; moisture, temperature, and other weather sensors; accelerometers; sensors attached to mechanical traction control, breaking, and steering systems; vehicle control (steering, accelerator, break pedal) monitoring systems) in raw form may not be stored at a level of abstraction in line with how a human would identify a scenario of interest (e.g., an off nominal situation where additional driving system training or verification is desired).

Systems and methods as described herein are configured to modify, annotate, or otherwise augment the multi-sensor data captured by vehicles to make that data amenable to location by search for driving system training and verification. In embodiments, those systems and methods are configured to compress collected driving data and to classify that data into a sequence of states. Combinations of those states may be searched, along with other ancillary data to identify and extract driving scenarios of interest. Attachment of this state-based metadata enables fast location of driving scenarios of interest, enabling efficient training of autonomous vehicle models for handling those scenarios and for established system verification.

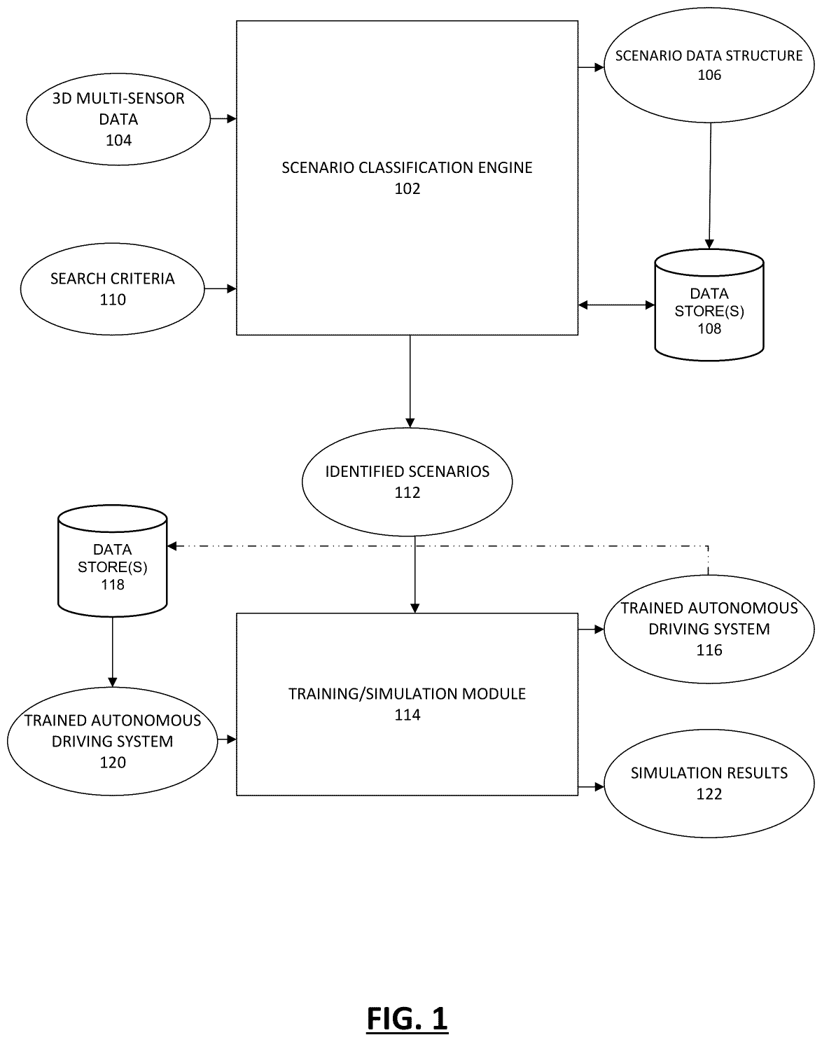

FIG. 1 is a diagram depicting a scenario classification engine and training/simulation module. A scenario classification engine 102 receives three dimensional multi-sensor data associated with a plurality of real-world drives in one or more sensor equipped vehicles. A real-world drive may take the form of a single operation of a vehicle from ignition to turning off or subsets or supersets thereof. The multi-sensor data may take the form of raw data from onboard vehicle sensors. The multi-sensor data may further include processed data (e.g., averages, trends, annotations) and data from sources outside of the vehicle (e.g., map data from a third party provider). The scenario classification engine 102 is configured to augment the three dimensional multi-sensor data 104, such as by adding annotation data to the multi-sensor data to make scenarios within that three dimensional multi-sensor data more accessible. For example, the scenario classification engine 102 may be configured to analyze the three dimensional multi-sensor data and to identify drive states (e.g., states of a finite state machine) that indicate a status of a drive at different points in time within that drive (e.g., every one second, every five seconds). The sequence of states identified by scenario classification engine 102 is associated with the three dimensional multi-sensor data in a scenario data structure and provided at 106 for storage a non-transitory computer-readable data store 108.

Those scenarios contain multi-sensor data and state sequence annotations 106 store in the data store 108 can then be searched via one or more search criteria 110, where the search criteria 110 may include state criteria indicating a pattern of states that are of interest in scenarios that are the target of a search. Scenarios in the data store 108 that match the search criteria are output from the scenario classification engine 102 as identified scenarios 112 for further processing, such as by a training/simulation module 114. For example, the search criteria 110 may identify a pattern of driving states associated with scenarios that the query seeks to extract from the data store 108 as identified scenarios 112. In an instance where the search seeks to identify scenarios where a vehicle of interest (the “ego” vehicle) is overtaken by a vehicle on its left, the search criteria 110 may specify a pattern of (1) a “left lane back” state, indicating the overtaking vehicle at the back left of the ego vehicle, (2) an “ego side” state, indicating the overtaking vehicle at the left side of the vehicle, (3) an “on lane border” state, indicating the overtaking vehicle on the lane dividing line in front of the ego vehicle, and (4) an “ego lane front” state, indicating the overtaking vehicle in the lane in front of the ego vehicle. Scenarios in the data store 108 that match 110 (one or more left lane back states, followed by one or more ego side states, followed by one or more on lane border states, followed by one or more ego lane front states) are returned by the scenario classification engine 102 as identified scenarios. On output from the scenario classification engine 102, the identified scenarios 112 may be used by the training/simulation module 114 for training or verification of an autonomous driving system 116.

During a training phase, the training/simulation module 114 may provide identified scenarios 112 to an autonomous driving system (e.g., a neural network system) for training that autonomous driving system. The training/simulation module 114 may be configured to augment network link weights in the autonomous driving system based on the identified training scenarios 112 associated with the state pattern of the search criteria 110 so that the autonomous driving system 116 may better handle similar occurrences in the real world. After one or more (e.g., many tens, hundreds, thousands) identified scenarios 112 are utilized for training, the training/simulation module 114 outputs the trained autonomous driving system 116 for storage in a data store 118 (e.g., the same or different data store as 108).

During a verification phase, the training/simulation module 114 may provide identified scenarios 112 to a trained autonomous vehicle driving system 120 that is accessed from the data store 118 to simulate how well that driving system 120 handles those scenarios. For example, the training/simulation module 114 may provide the three dimensional multi-sensor data associated with a scenario, representing the ground truth experienced by the corresponding real world drive of a vehicle, to the trained autonomous driving system 120 and capturing the drive commands issued by that autonomous driving system 120 using physics simulation (e.g., using a mechanical engineering/physics simulation engine). An evaluation of the simulation results 122 indicates how well the autonomous driving system 120 would have handled that scenario if it occurred in the real world. For example, the training/simulation module 114 may compare the commands of the autonomous driving system 120 to those issued by a human during the corresponding real world drive to determine whether the autonomous driving system's 120 reaction to the scenario was appropriate. Instances where the behavior of the autonomous driving system 120 is inappropriate may indicate a need for further training, such as using training data associated with scenarios similar to that provided driving system 120. Where the autonomous driving system 120 repeatedly reacts appropriately to the provided scenarios 112, the autonomous driving system may be deemed sufficiently trained for further testing (e.g., real world field testing) or for release into production.

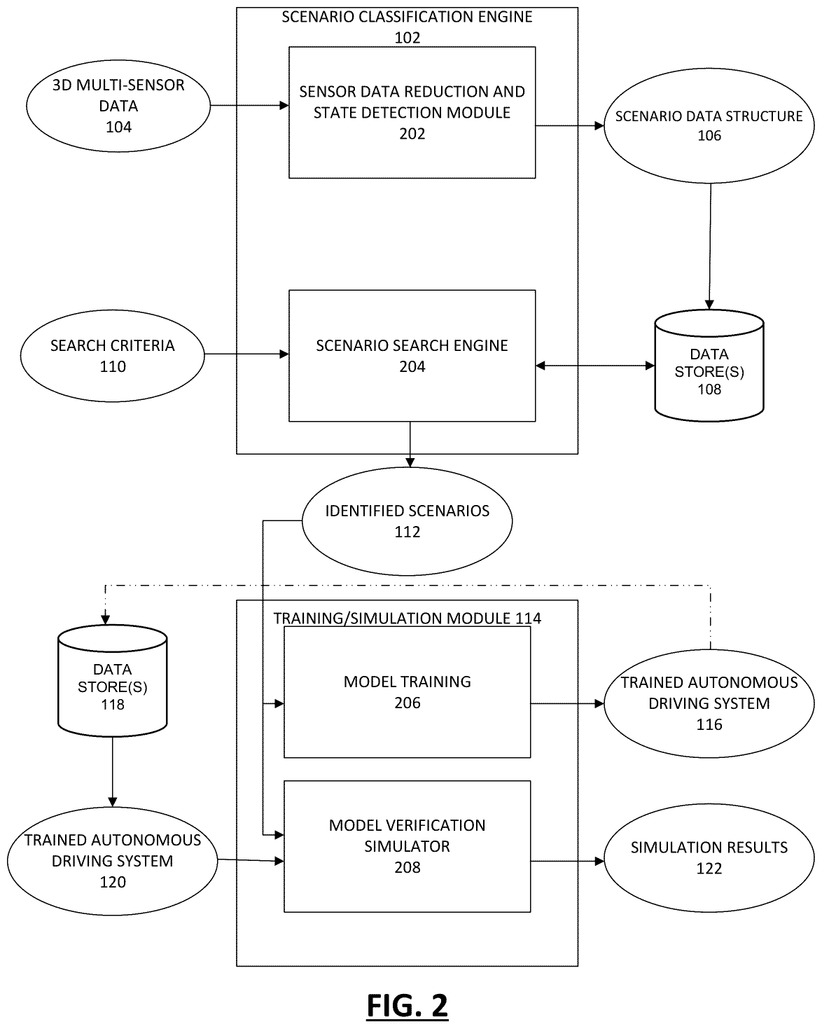

FIG. 2 is a diagram depicting additional detail of an example scenario classification engine and training/simulation module. The scenario classification engine 102 receives or otherwise accesses three dimensional multi-sensor data 104 associated with a plurality of real-world drives in a sensor equipped vehicle. A sensor data reduction and state detection module 202 processes the 3D multi-sensor data 104 to generate scenario data structures 106 that contain multi-sensor data for a scenario along with sequences of states associated with the scenario and other computed or annotated data. For example, the data reduction and state detection module 202 may take the three dimensional multi-sensor data 104 associated with a real world drive and divide it into segments (e.g., segments of common lengths like 10 seconds, 30 seconds, 1 minute; segments broken up at boundaries where little dynamic activity is detected in the sensor data 104).

The module may perform data cleanup and reduction prior to state detection. For example, the multi-sensor data may include data indicative of lines on a road, such as dashed lines dividing lanes on the road. In instances where another vehicle is driving on the line obscuring the sensors vision, such as during a lane change, the line-indicating data may be interrupted. The data reduction and state detection module 202 may use data from other sensors or interpolation techniques to estimate the location of the lane dividing line in instances where it is missing. Similarly, the module 202 may estimate the location of other vehicles and obstacles that may be temporarily hidden from view by intervening objects. The module 202 may also correct a location of the ego vehicle, such as verifying sudden movement indicated by GPS data with lane-indicating line sensing to correct for erroneous location data in the multi-sensor data. The data reduction and state detection module 202 may further reduce the multi-sensor data 104 or annotate that data at a higher level of abstraction than the received multi-sensor data 104. For example, the multi-sensor data 104 is three dimensional in nature (e.g., three dimensional lidar point clouds indicating returns that may be associated with other vehicles or obstacles). That three dimensional data may be important to retain as ground truth associated with a scenario in some instances. But reduced data may be generated in addition or in the alternative for use in determining the sequence of states to associate with the scenario data structure 106. In once example, for a particular drive (e.g., a full drive, a segment of a drive), the three dimensional multi-sensor data may be reduced to a time series of two dimensional representations. For example, three dimensional raw sensor data may be reduced to a time series of two dimensional representation of road markings, obstacles, and other vehicles relative to the ego vehicle.

Following any data cleanup and reduction, the data reduction and state detection module 202 determines a sequence of states to associate with the drive. In one example, the module 202 classifies the time series of two dimensional representation into a sequence of states (e.g., one state per two dimensional representation in the series), such as through the use of a finite state machine. In embodiments, a state classification associated with a particular two dimensional representation in the time series may consider that particular two dimensional representation as well as near in time two dimensional representations or state classifications, as described further herein. Once a sequence of states has been classified for the scenario, the scenario is output from the scenario classification engine 102 as a scenario data structure 106 for storage in the data store.

The scenario classification engine 102 further includes a scenario search engine 204 that facilitates accessing scenario data structures 106 that match a state criteria specified in the search criteria 110 of a query. For example, the query may specify that it is seeking scenarios that include “left lane back” state(s) followed by “ego side” state(s), followed by “on lane border” state(s), followed by “ego lane front” state(s). The search criteria may further specify that the returned scenarios have been captured at night on a left hand curve in foggy conditions. The scenario search engine 204 identifies scenarios that meet all (or most or some) of those criteria and returns those scenario data structures (or links thereto) as identified scenarios 112.

As described above, identified scenarios 112 may be used for training and simulation of an autonomous driving system using module 114. In a training mode, the three dimensional multi-sensor data of an identified scenario 112 is provided to an autonomous driving system at 206 to train an artificial intelligence model of the autonomous driving system. Typically multiple identified scenarios 112 are provided to train the model in an iterative fashion, where the three dimensional multi-sensor data of other identified scenarios 112 that meet the state criterial of the query 110 are provided to the autonomous driving system 116 for training. The trained model is then provided to the data store 118 for storage.

Identifies scenarios 112 may also be used for verification of a trained autonomous driving system 120. A trained autonomous driving system 120 is accessed from the data store 118 and provided to a model verification simulator. The three dimensional multi-sensor ground truth data of a identified scenario 112 is accessed by the model verification simulator 208 and provided to the autonomous driving system 120 to simulate behavior of the autonomous driving system 120 when faced with the sensor data of the identified scenario. The results of the driving commands provided by the autonomous driving system 120 when receiving the sensors data of the scenario 112 are determined via simulation, where a review of the simulation results 112 is performed to determine whether the autonomous driving system 120 reacted appropriately to the scenario 112.

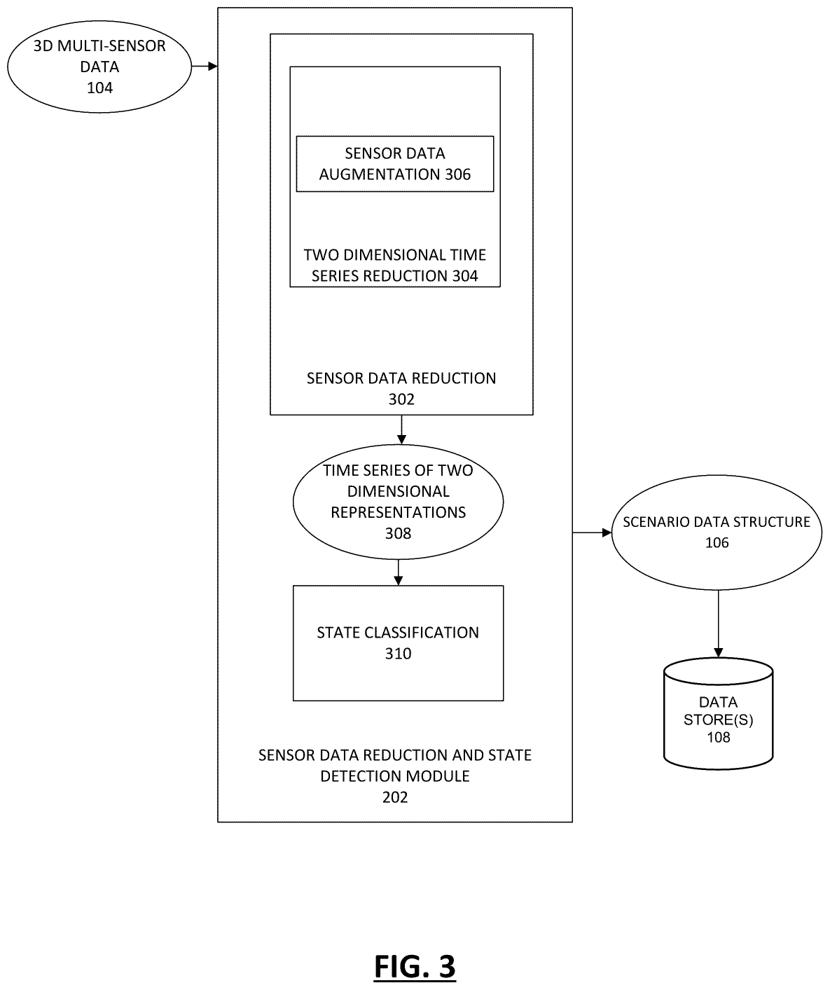

FIG. 3 is a diagram depicting example details of operations performed by a sensor data reduction and state detection module. The sensor data reduction and state detection module 202 receives 3D multi-sensor data 104 and provides that data 104 for reduction at 302. The data reduction seeks to consolidate the often large amount of cumbersome three dimensional data into a two dimensional time series representation of objects 308 relative to the ego vehicle. In some instances, that data reduction further includes data augmentation at 304. Data augmentation 304 may include processing to cleanup raw sensor data that is of suboptimal quality. For example, two dimensional time series reduction 302 may include consolidating a plurality of points in three dimensional space into a location of a particular object on a two dimensional plane. That example may further include identifying missing or erroneous data associated with a first sensor and using interpolation at 306 to determine replacement data. That replacement data may be accessed from another sensor in the multi-sensor data or another data source, such as external map data. In the example, the replacement data may then be used to determine the location of the particular object in two dimensional space as part of the two dimensional time series reduction 304. In another example, interpolation may be performed using known locations of the particular object at a prior or subsequent point in time in the time series. For example, the sensor data augmentation module 304 may track a confidence level associated with the location of the particular object in two dimensional space based on data from one or more sensors 104. When location confidence is low, the module 304 may interpolate based on prior or subsequent two dimensional positions of the particular object where the module 304 has a higher degree of confidence.

Once a time series of two dimensional representations has been generated at 304, a state classification module classifies the time series of two dimensional representations into a sequence of states. The two dimensional time series from 304 represents positions of objects relative to the ego vehicle (e.g., x-y positions, distances) at each of a plurality of times within a scenario (e.g., every 0.1s, 0.5s, 1.0s, 5.0s). Those objects may include other vehicles, obstacles, road signs, road markings, road controls (a stop light), people, or animals. A state classification module 310 classifies the time series of two dimensional representations into a sequence of states that are representative of the two dimensional representation. For example, for a particular two dimensional representation that identifies a relative location of a vehicle (−20 meters in the x direction, −30 meters in the y direction) and dashed lane markings (−1 meter in the x direction) to the ego vehicle, the state classification module 310 may classify the two dimensional representation as a “left lane back” state. The sequence of states determined by the state classification module 310 may be appended to a scenario data structure along with the 3D multi-sensor data (or a location thereof) in a scenario data structure 106 that is provided for storage in data store 108.

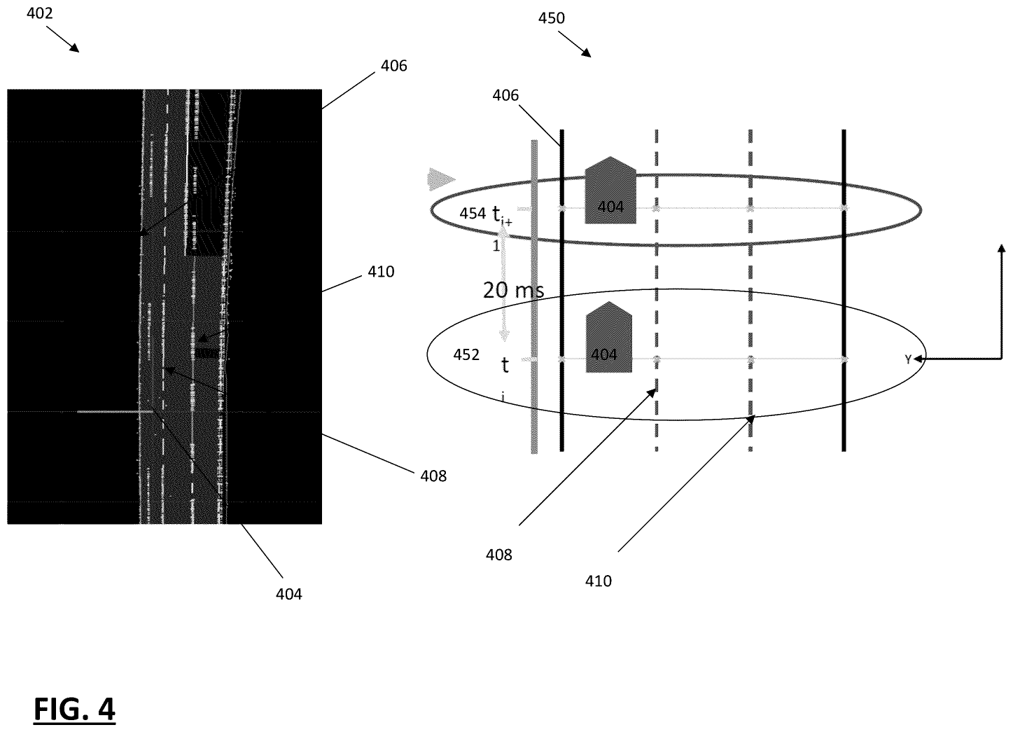

FIG. 4 is a diagram depicting example reduction of three dimensional sensor data to a two dimensional representation. The visualization at 402 provides lidar returns from a sensor positioned on an ego vehicle at 404. The lidar returns are compressed from their three dimensional form to the two dimensional representation at 402, which may be accomplished, for example, by identifying an entity at any (x, y) position where a lidar hit is detected, regardless of the height of that hit in the z direction. A two dimensional time series reduction module recognizes signatures of objects in the representation and transforms that processed data representation 402 into two dimensional representations, two of which are illustrated at 450, that indicate the position of recognized objects relative to the ego vehicle 404. In the example of FIG. 4, the time series reduction module recognizes the position of a lines on the road including a left hand side solid line 406, a first dashed lane indicating line 408, and a second dashed lane indicating line 410. The time series reduction module reduces the sensor data at 402 into two two dimensional representations, 452, 454, where each of those two dimensional representations 452, 454 indicates distances of road lines 406, 408, 410 relative to the ego vehicle 404 at different instances of time, where two dimensional representation 452 is associated with time t, and two dimensional representation 454 is associated with time t+1, 20 ms after time t. Note that while the two dimensional representations of FIG. 4 are depicted in graphical form, those representations may be processed and stored in other form (e.g., line 408 is assigned object reference 1001, where object 1001 is +0.8 m in the x direction from the ego vehicle at time t and +0.7 m in the x direction from the ego vehicle at time t+1, where a database table stores records: 1001, t, +0.8; 1001; t+1, +0.7).

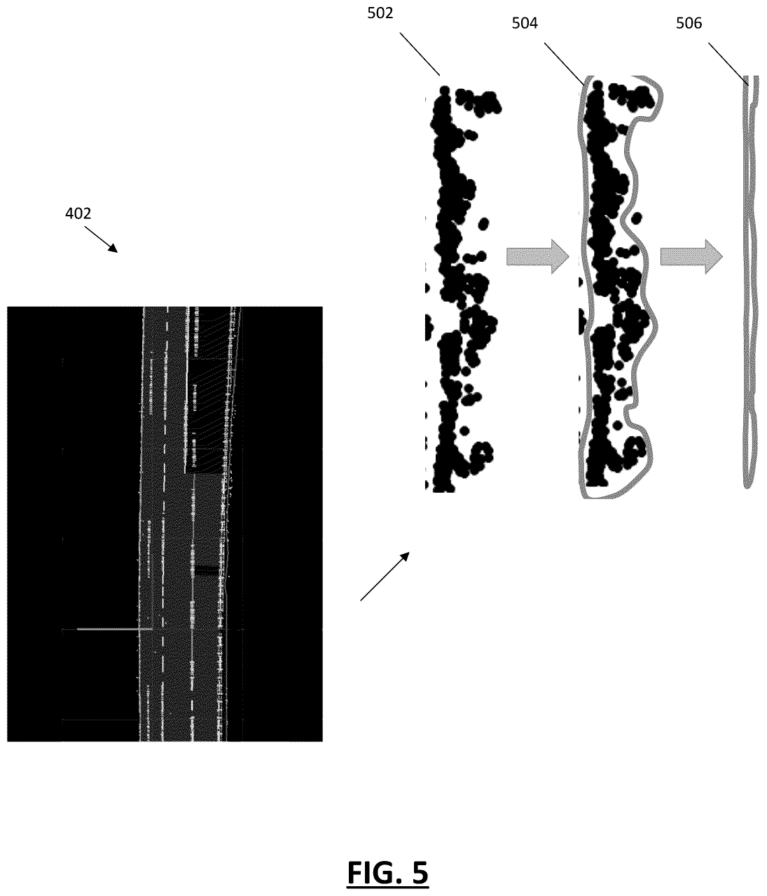

FIG. 5 is a diagram depicting an example intermediate step in transitioning from the lidar representation 402 to the time series of two dimensional representations 450. In its more raw form at 402, the lidar hits are not actually uniform in a line. The lidar hits are scattered in nature, as illustrated in the magnification of 502. In one example, the location of a line on the road, such as the left hand solid line, is determined by bounding points that are clustered together within an area and assuming that those points are part of a common object. That area depicted at 504 is irregular in shape but is substantially a long vertical rectangle shape. That point encompassing boundary at 504 is deflated to realize that vertical rectangle shape at 506, where the center of that deflated boundary 506 may be used to calculate the relative difference of the solid left line of the road relative to the ego vehicle.

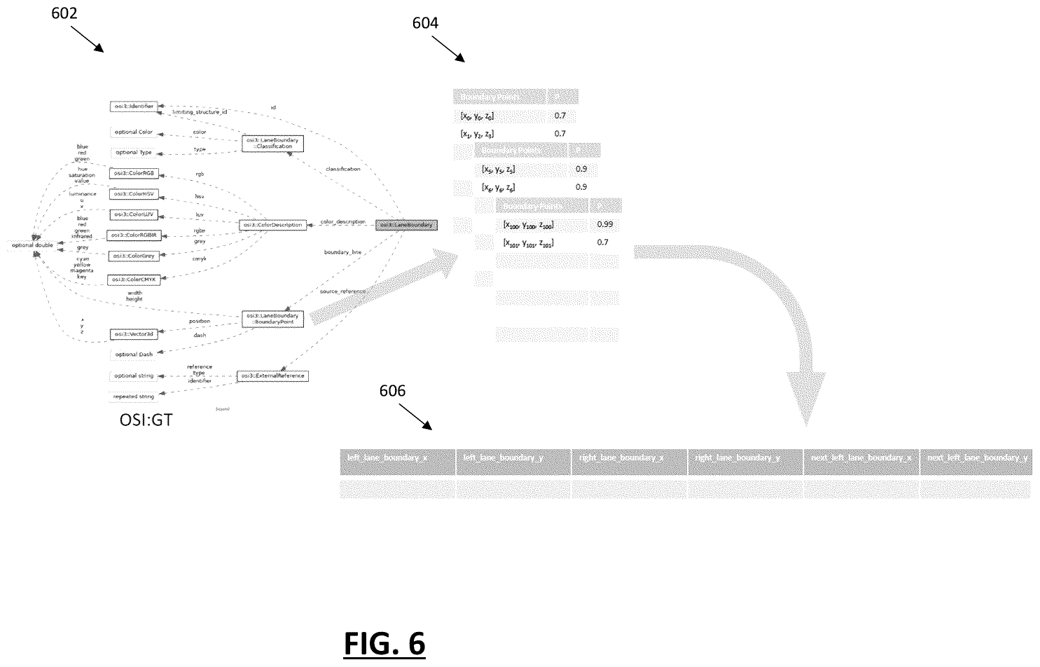

FIG. 6 illustrates example data structures for converting three dimensional sensor data to a two dimensional representation for lane indicating lines. Data is received by the scenario classification engine as raw multidimensional data from the lidar sensor at 602. That raw data includes position data indicating lidar hits as well as other data such as the color of objects associated with the lidar hit. Certain of that data, including the color data, may be useful for training and verifying effectiveness of an autonomous driving system, but that data may be less critical for creating state information for making scenarios more easily locatable by search. So while that ancillary color data may be retained in the raw data portion of the scenario data structure (where the raw data may be located in the scenario data structure or in an alternate location identified by the scenario data structure), that data is filtered from the identification of locations of objects relative to the ego vehicle. As depicted at 604, the multidimensional lidar data is reduced to object candidate data structures at 606. Those object candidate data structures indicate locations of candidate objects and confidence values (P) indicating that an object has been correctly identified. When an object is identified as being a particular lane boundary with a high enough level of confidence, the location of that particular lane boundary relative to the ego vehicle is stored in a flat data structure at 606 as part of a two dimensional representation in a series of two dimensional representations.

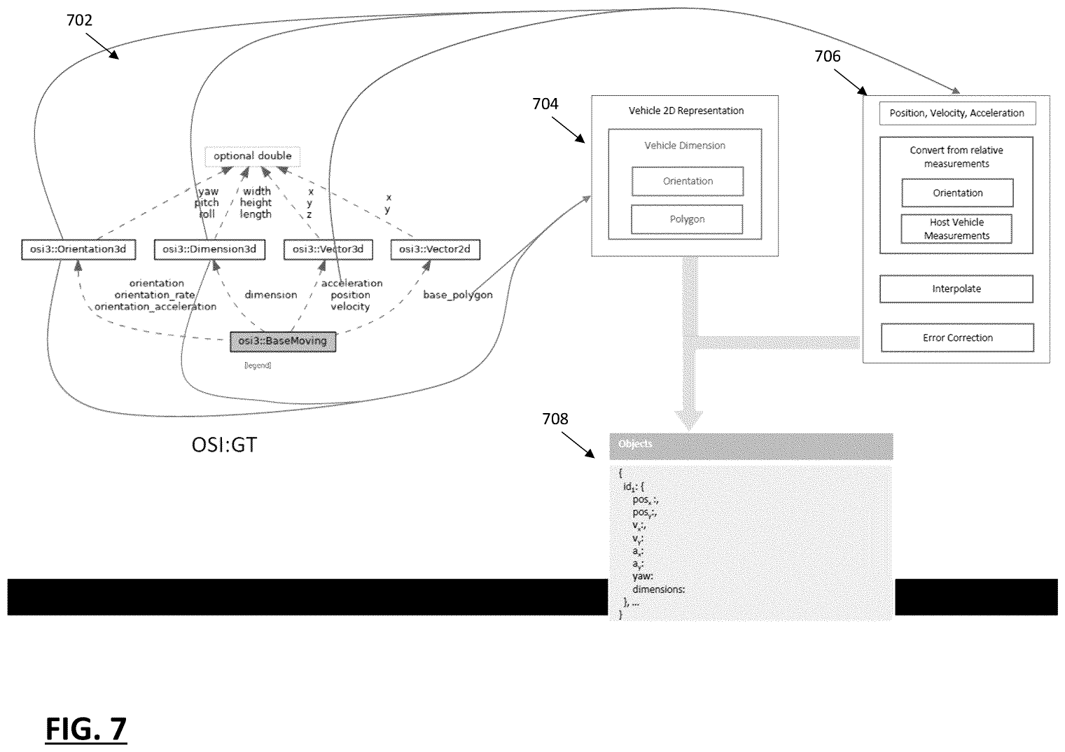

FIG. 7 illustrates example data structures for converting three dimensional sensor data to a two dimensional representation for a detected object. Data is received by the scenario classification engine as raw multidimensional data from one or more sensors, such as lidar, radar, camera, or other sensors. That multidimensional data includes data describing the size of the detected object (width, height, length), its position, its orientation, and vectors associated with its movement. That multidimensional data is processed to provide a representation of the object (in this case a vehicle) at 704 with a data structure that provides a polygon description of the shape of the vehicle and a value indicating the vehicle's orientation. A second data structure at 706 provides dynamic data about the vehicle, as extracted from the multidimensional data at 702, including data regarding position, velocity, and acceleration. Those dynamic values may be in absolute terms or relative to the ego vehicle. The dynamic data structure at 706 may be augmented based on interpolation, error correction, or other processing, such as described herein. At 708, the vehicle description data 704 and dynamic data 706 are further reduced to a two dimensional representation of the object relative to the ego vehicle in a flat data structure that identifies position, velocity, acceleration, orientation, and dimension data.

As noted above, in some instances data in the multi-sensor data may be missing or erroneous. This could result from sensor errors (e.g., a camera sensor malfunctioning or being covered by debris). Additionally, data may be missing or incorrect even when all sensors are functioning properly. For example, a vehicle two lanes away may not be sensed for a period of time when another vehicle passes between the ego vehicle and that vehicle two lanes away. Interpolation may be used, in some instances, to fill in missing or erroneous data.

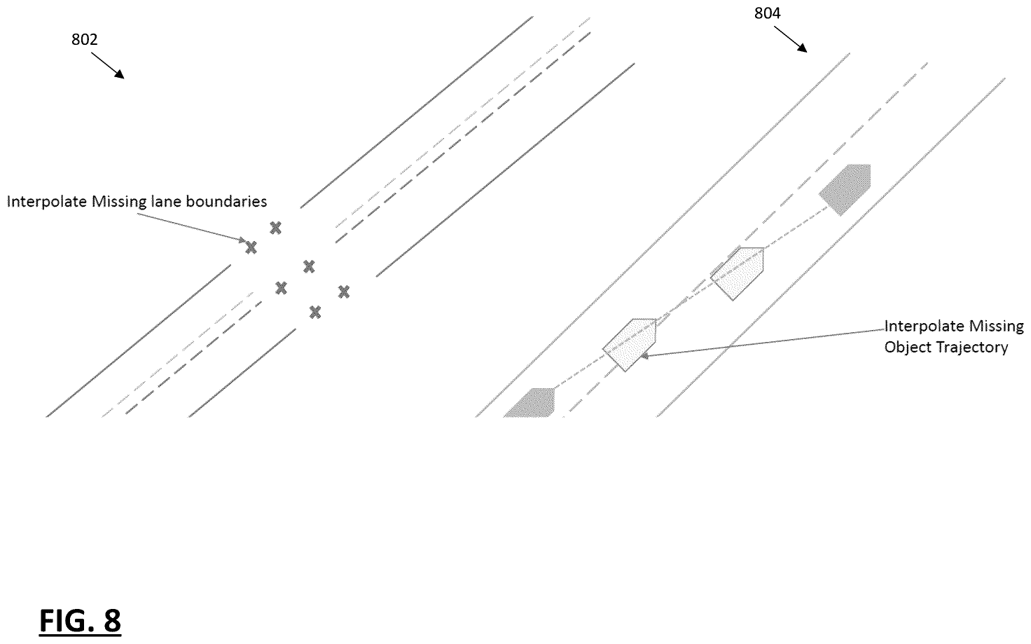

FIG. 8 is a diagram depicting interpolation of lane indicating road marking data and vehicle location data. FIG. 8 provides a visualization of missing lane marking data. Lane making data on a highway is typically continuous in nature, such that missing lane marking data (e.g., across all lanes for a period of time) may indicate missing or erroneous data. In that instance, a system may evaluate whether the break in the lane marking data is likely to be missing data, such as by considering the location of the drive (e.g., a highway where gaps in lines are less likely than in a city with intersections), the speed of travel, the presence of lane marking data before and after the break in the lane marking data and the orientation of those present lines. Where the context of the break indicates probable missing data (e.g., highway conditions where commonly oriented lane marking data is present before and after the break), a sensor data augmentation module may use interpolation to fill in what is deemed missing or erroneous lane marking data.

Similarly at 804, the presence of another vehicle is detected at the left of the ego vehicle travelling in the right hand lane at a first instance, is not detected in the next two instances, and then is detected in front of the ego vehicle at a fourth instances. A system may evaluate a likelihood that the vehicle should have been detected in the second and third instances but for a sensor error or obstruction. The system may evaluate whether there are any indications that the other vehicle may not have been present during the second and third instances, such as indications of a highly dynamic situation (e.g., a crash flag). If the first through fourth instances are detected to have occurred during a relatively typical period, then the sensor data augmentation module may use interpolation to fill in what is deemed to be missing or erroneous vehicle detection data.

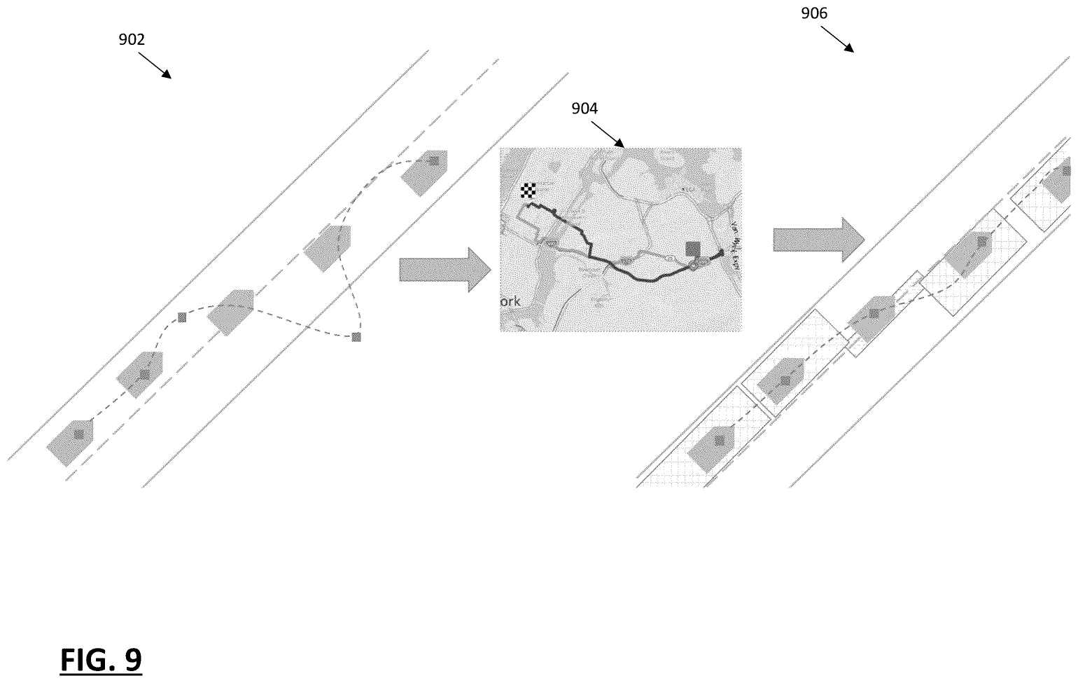

A system may further use contextual information to determine that data is erroneous and a candidate for correction. FIG. 9 is a diagram depicting correction of location data of an ego vehicle. In FIG. 9, the position of the ego vehicle is identified at five instances based on data received from a GPS sensor on the vehicle. That location data is deemed potentially anomalous at the third and fourth of the five instances, which indicate the vehicle slowing quickly and then veering off of the right side of the road before returning to the right lane. This data could be correct, for example, if the data corresponded with a swerving event. The system may cross reference the detected anomaly with other data, such as accelerometers, break controls, and steering controls to determine whether a swerve event occurred. If not, the sensor data augmentation module may seek to rectify what it deems erroneous data (e.g., an error in GPS data caused by driving under a bridge). The module may use interpolation between the second and fifth instances to correct the erroneous data, or the module may reference other sensors or an external data source, such as third party map data to determine a likely location of the vehicle during the third and fourth instances (e.g., map data indicating a straight or a curved road). The module may interpolate locations for the third and fourth instances based on the shape of the road indicated by the third party map data.

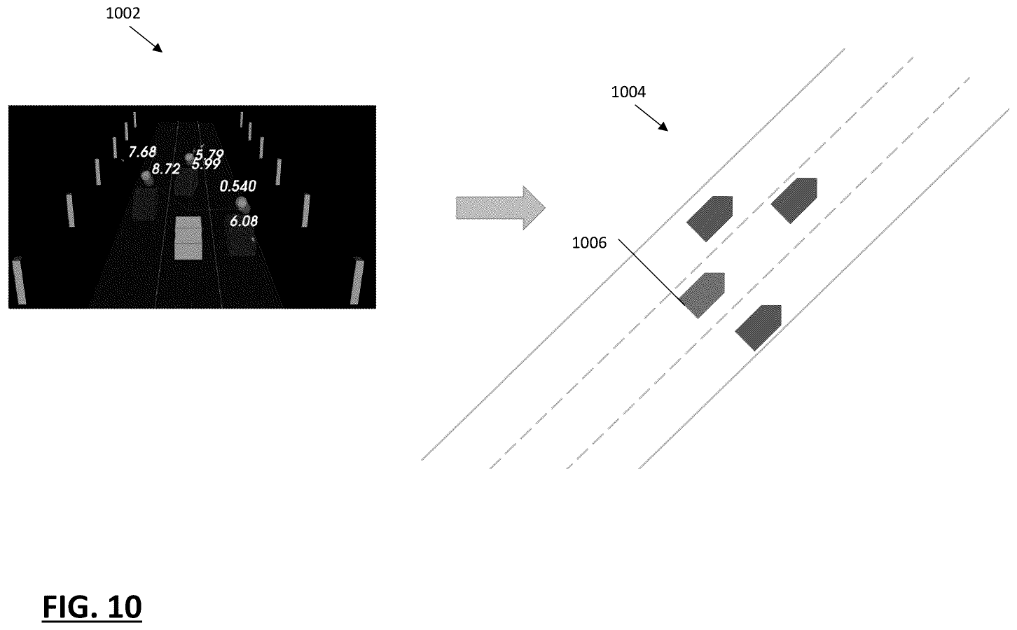

As described above, the sensor data reduction module accesses three dimensional multi-sensor data. It processes that data to reduce the three dimensional multi-sensor data to a time series of two dimensional representations. FIG. 10 is a diagram depicting a reduction of a point in time for which three dimensional multi-sensor data is reduced into one two dimensional representation. As depicted at 1002, the three dimensional multi-sensor data tracks positions, relative velocities, and three dimensional shapes of multiple vehicles, lane indications, and obstacles (e.g., street lights) relative to the ego vehicle. The two dimensional time series reduction module reduces that data to a two dimensional representation at 1004 that identifies relative positions of the objects deemed to have a highest priority, in this instance the location of lane indications and other vehicles relative to the ego vehicle 1006. In the two dimensional representation snapshot, the relative positions of the vehicles relative to the ego vehicle are identified as well as the location of all of the vehicles across the three lanes of travel. This process of reduction to a two dimensional representation may be repeated periodically (e.g., every 0.1 s, 0.5 s, 1.0 s or time or every 10 m, 100 m driven) to provide a time series of two dimensional representations.

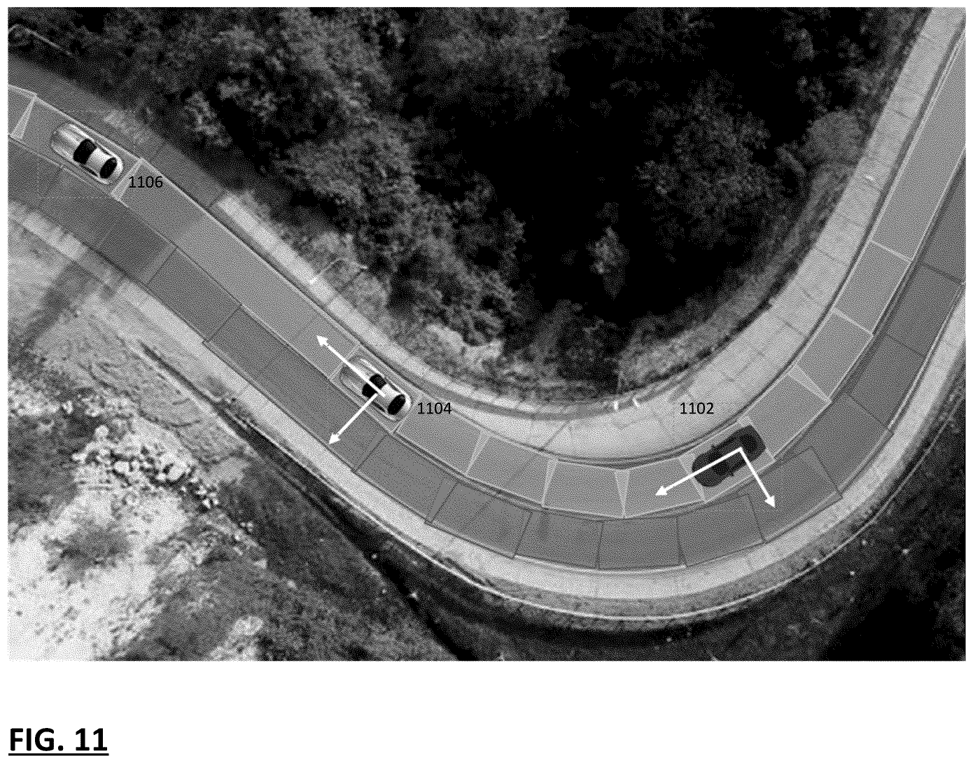

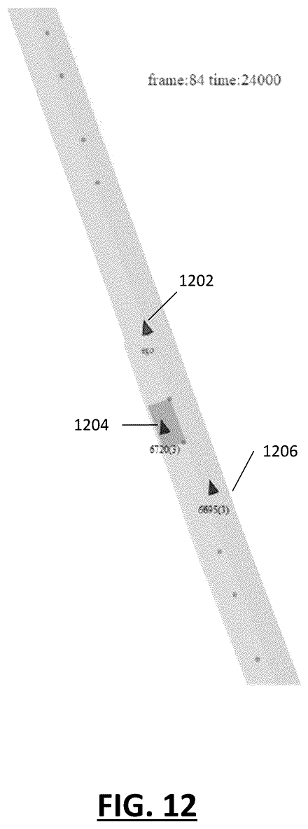

FIG. 11 is a diagram depicting a visualization of a time series of two dimensional representation. A two dimensional representation is generated at each block, such as every 0.1s. In the example of FIG. 11, the ego vehicle 1102 is travelling in the right lane of a curvy road, with two other vehicles 1102, 1104 travelling ahead of it in the left lane. The example of FIG. 11 illustrates the benefit of context in reducing multi-sensor data to a time series two dimensional representation. In isolation, looking at the moment where the vehicles 1102, 1104, 1106 are in FIG. 11, it would be difficult for a system to determine the relative state of the three vehicles. In reality, all three vehicles are travelling in the same lane. But the curves in the road make this unclear from a single snapshot, where the position and orientation of the vehicles is much different than what a system would see when three vehicles are travelling in the same lane on a straight road. The dynamic nature of the curved road complicates the system's analysis. But in a system such as that depicted in FIG. 11, context from prior or later moments in time can be used to extrapolate the current situation. For example, where the ego vehicle 1102 has previously detected that vehicles 1104 and 1106 are travelling in the same lane as the ego vehicle 1102, and where the ego vehicle 1102 has not detected either of those other vehicles 1104, 1106 driving on the lines indicating the lane border, the system may be able to assume with sufficient confidence that those other vehicles 1104, 1106 remain in the same lane despite their non-aligned locations and skewed orientation. This can be verified, in some instances, with reference to external map data to confirm the curved nature of the road. FIG. 12 is a diagram depicting a tracking of relative positions of first and second vehicles 1204, 1206 relative to an ego vehicle in a two dimensional representation, where the road has been normalized to remove curves from consideration.

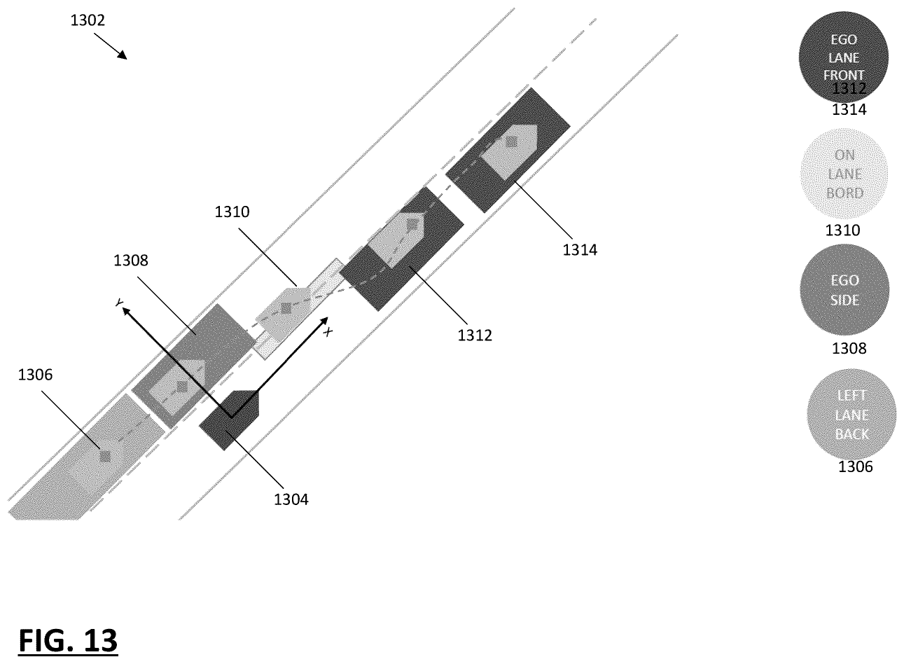

Following reduction of the three dimensional multi-sensor data to a time series of two dimensional representations in one example, the time series of two dimensional representations is classified into a sequency of states. FIG. 13 is a diagram depicting classification of time series of two dimensional representations into a sequence of states. The left side of FIG. 13 at 1302 illustrates a time series of two dimensional representations spanning five instances in time, where a vehicle is overtaking the ego vehicle 1304 on the left and then cutting in front of the ego vehicle 1304 into the right lane. In the first instance 1306, the vehicle is wholly behind the ego vehicle 1304 in the left lane. The sensor data reduction module classifies the two dimensional representation of instance 1306 into a left lane back state. In the second instance 1308, the vehicle is beside the ego vehicle 1304 in the left lane. The sensor data reduction module classifies the two dimensional representation of instance 1308 into an ego side state. In the third instance 1310, the system detects that the target vehicle is on the lane border crossing from the left to the right lane. The sensor data reduction module classifies the two dimensional representation of instance 1310 into an on lane border state. In the fourth and fifth instances 1310, 1312, the vehicle is in front of tje ego vehicle 1304 in the right lane. The sensor data reduction module classifies the two dimensional representation of instances 1310, 1312 into an ego lane front state.

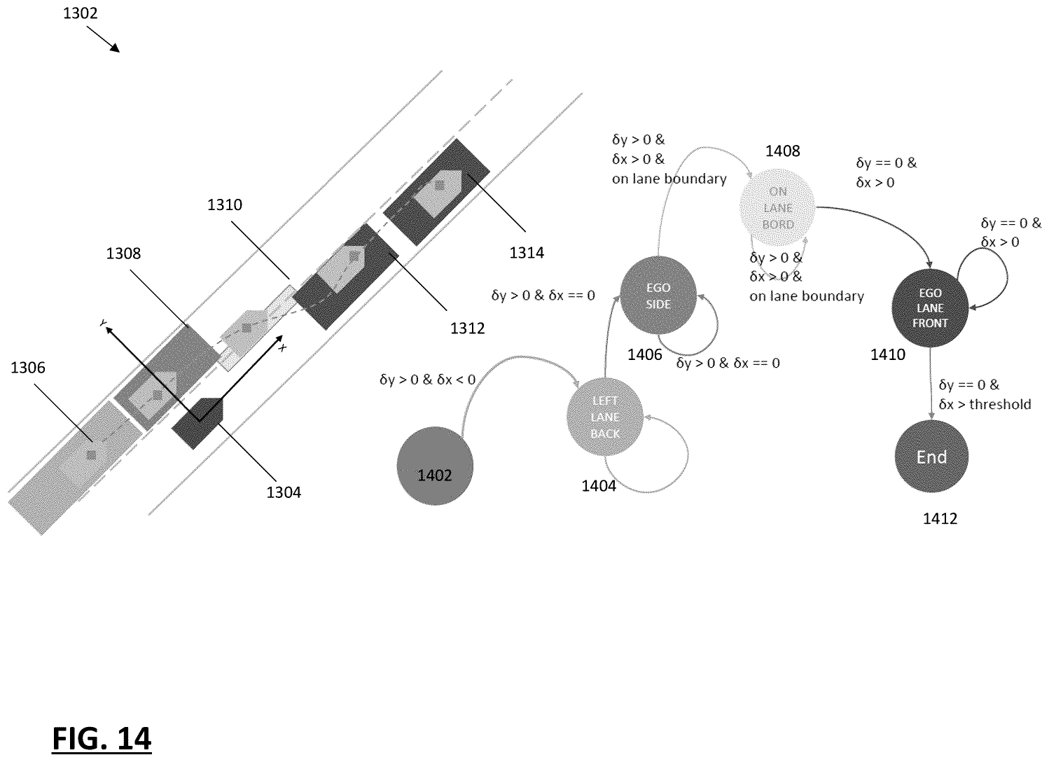

In some examples, the sensor data reduction module classifies using a finite state machine process. FIG. 14 depicts a portion of a finite state machine for classifying a time series of two dimensional representations into a sequence of states. FIG. 14 depicts the five instances 1306, 1308, 1310, 1312, 1314 depicted in FIG. 13. State 1402 depicts a start of the process or a time in the sequence of states where no vehicles are depicted near the ego vehicle 1304. At instance 1306, a vehicle is detected behind the ego vehicle (x<0) and to the left of the ego vehicle (y<0). This indicates the state of the system should change to a left lane back state 1404. Should that arrangement of vehicles remain, the sequence of states would not change in the second instance (as indicated by the arrow back to state 1404) or a second instance of the left lane back state 1404 would be reported. In instance 1308, the vehicle has moved even with the ego vehicle 1304 in the x direction (x==0), while remaining to the left in the y direction. This dictates a change in state from 1404 to the ego side state 1406. In instance 1310, the other vehicle is identified as being in front (x>0) of the ego vehicle 1304 and still to the left (y<0). The detected vehicle is further detected as being on the line bordering the left and right lanes (on lane border=true). This indicates a change in state from 1406 to the on lane border state 1408. In instance 1312, the target vehicle is in front (x>0) of the ego vehicle 1304 and even (y==0) with the ego vehicle 1304 indicating a change in state from 1408 to the ego lane front state at 1410. Those relationships remain in instant 1314, which may indicate that state 1410 should again be recorded in the sequence of states. That state 1410 may continue to be recorded until the target vehicle moves beyond a threshold distance from the ego vehicle 1304 in x direction as it pulls away (x>threshold).

As noted above, the depicted finite state machine of FIG. 14 may not be complete and other transitions may be possible, such as from ego side 1406 back to left lane back 1404 should the passing car fail to overtake the ego vehicle 1304. In some implementations, it may not be possible to transition immediately from one state to another. For example, it may not be possible for a transition from left lane back to right lane front because it would be very rare, if not impossible, for the target vehicle to transit from the back left to front right of the ego vehicle over the period of a single instance. Thus, the particular next state of the sequence of states may be determined based on a prior state, and the particular next state may be selected from a subset of all possible states, where the subset excludes impossible or unlikely states based on the current or past states.

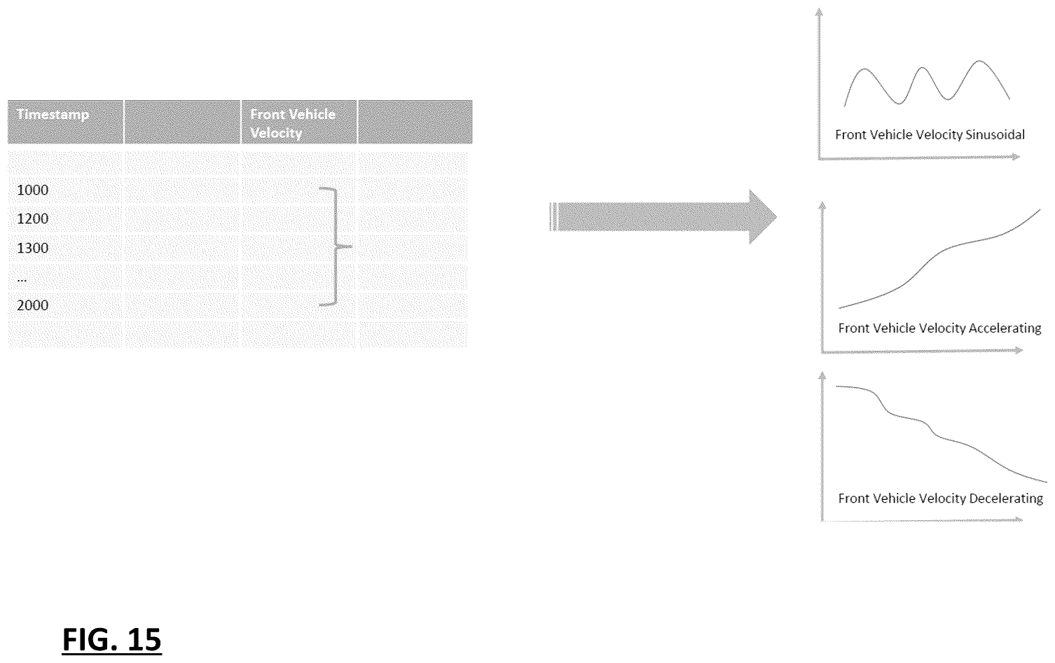

In addition to determining and recording state information during a drive, a system may further derive other metrics regarding a drive or portions of a drive that may then be searchable when seeking scenarios of interest. FIG. 15 is a diagram depicting monitoring of a target vehicle in front of the ego vehicle over time to identify a velocity pattern of that target vehicle. In this example, the scenario classification engine (or other system entity) tracks the velocity of a vehicle in front of the target vehicle over a period of time (e.g., every 1 second, every 2 seconds). The engine then characterizes that velocity data, such as indicating a generally sinusoidal behavior, a generally accelerating behavior, or a generally decelerating behavior. This front vehicle data may be indicative of what is happening in a stored driving scenario, such as stop and go traffic, approaching a traffic jam, freeing up from a traffic jam. This trend data may be stored in a scenario data structure for use in a scenario search, such as in combination with state data.

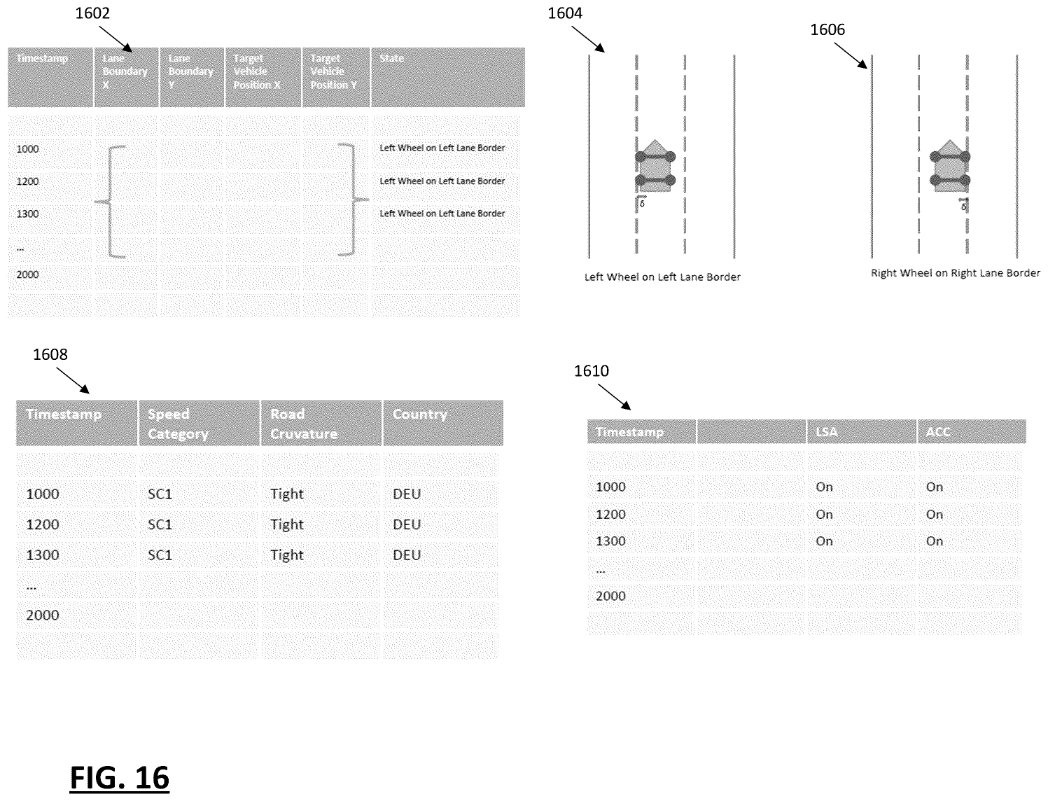

FIG. 16 depicts detection of additional vehicle conditions of interest that may be included in a scenario data structure for use in scenario searches. At 1602, a system tracks timestamps where an ego vehicle wheel is detected to be on a lane border, where a left wheel on a left border is illustrated at 1604 and a right wheel on a right border is indicated at 1606. Such a condition may be indicative of a lane change or driver failure to maintain their desired lane. At 1608, characteristics of a drive are detected, including a rate of speed (e.g., category 1: >130 km/hr; category 2: 101-130 km/hr; category 3: <101 km/hr), curvature of the road, and a country where the drive is occurring. At 1610, the system tracks the status of automated drive features of the vehicle including lane safety assist (LSA) and adaptive cruise control (ACC).

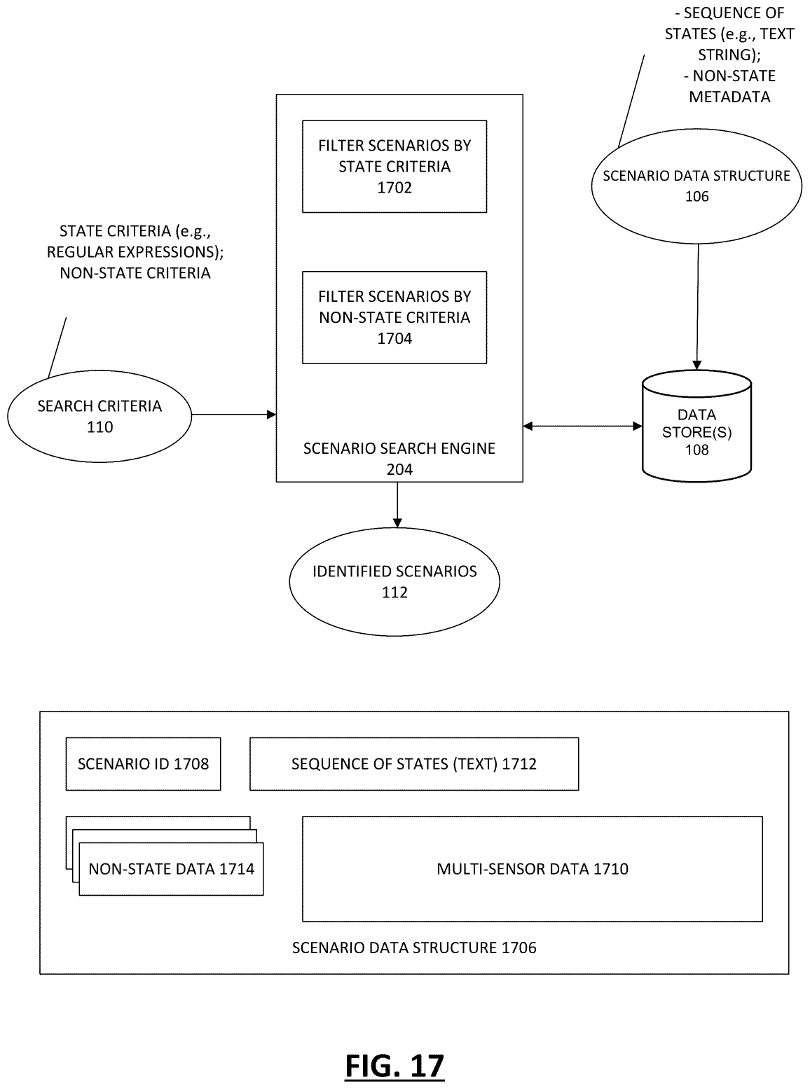

As noted above, after scenario data structures have a sequence of states associated with them, those scenario data structures can be located by search. FIG. 17 is a diagram depicting a scenario search engine and an example scenario data structure. A scenario search engine 204 receives search criteria 110, such as from a person or system seeking to train or verify function of an autonomous driving system. The search criteria 110 include a state criteria that, in embodiments, seeks a match in scenario databases. In one example, the state criteria are provided in the search criteria in the form of regular expressions describing the pattern of states sought in returns from the search. The search criteria 110 may include other non-state criteria a location, a vehicle velocity, a vehicle acceleration, a vehicle velocity pattern, a vehicle velocity trend, a traffic level, a time of day, a length of time, a weather condition, an event indication, a feature active indicator, a lane steering assistance active indicator, an adaptive cruise control indicator, an autonomous driving system active indicator, or a road curvature specification. The scenario search engine 204 references scenario data structures 106 stored in a data store 108 in identifying matches for the search criteria 110 to return as identified scenarios search results. The identified scenarios 112 may be output from the scenario search engine in a variety of ways as a collection of complete scenario data structures, as a set of identifiers (Scenario IDs) of scenarios that match the search criteria 110, or a set of pointers to scenario data structures that match the search criteria 110. The scenario search engine is configured to filter scenarios by the state criteria at 1702 and non-state criteria at 1704. Those filters may be done sequentially (e.g., using a criterion that is most likely to eliminate the most scenarios first, always state criteria first) or together in a single search.

FIG. 17 depicts an example scenario data structure at 1706. The scenario data structure 1702 may be stored in data store 108 for access by the scenario search engine 204. A scenario data structure 1706 may be associated with a scenario that may includes a recorded vehicle drive or portion thereof. The scenario data structure 1706 includes a scenario ID 1708, which may be a unique identifier associated with the scenario. The scenario data structure 1706 is associated with sensor data of the scenario, such as three dimensional multi-sensor data captured by the vehicle during a recorded drive. In some instances, the scenario data structure 1706 stores the multi-sensor data 1710. In other examples, due to the size of that sensor data, the scenario data structure 1706 may include an indicator of a location (e.g., a pointer, a file location) where the multi-sensor data is stored at 1710. The scenario data structure 1706 further includes data associated with the scenario that is amenable to search by the search engine 204. For example, the scenario data structure 1706 may include the sequency of states 1712 associated with the scenario. In one example, that sequence of states may be stored as a string of text identifiers (e.g., one character, two characters, three characters associated with each state in the sequence of states), where the search engine 204 is able to search that string for a match of the state criteria received at 110 using text searching techniques at 1702. The scenario data structure may further include non-state data 1714 (e.g., drive location, time of day, weather, vehicle velocity, event indications, feature activation, road type) that can be used for filtering scenario data structures at 1704.

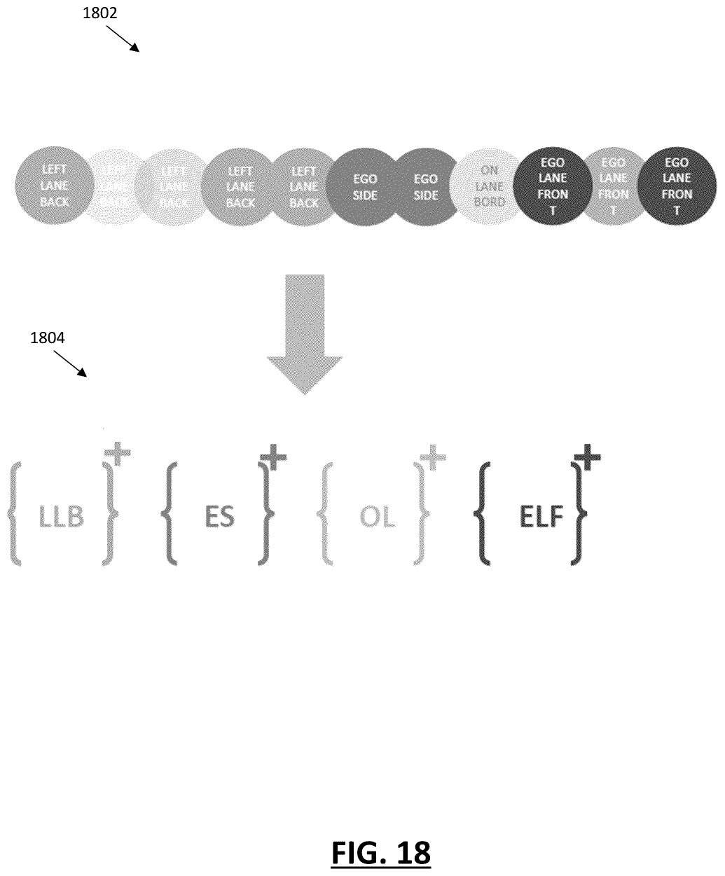

FIG. 18 is a diagram depicting an example state search criteria and a matching sequence of state. A portion of a sequence of states associated with a scenario in a scenario data structure is depicted at 1802. That sequence of states includes 5 left lane back (LLB) states followed by two ego side (ES) states followed by one on lane border (OL) state followed by three ego lane front (ELF) states. In one example, those states are represented in the scenario data structure as a string of characters: LLBLLBLLBLLBLLBESESOBELFELFELF. A state search criteria is received at 1804. In in the example of FIG. 18, the state criteria is shown as a regular expressions search criteria that seeks one or more (as indicated by the “+” sign) LLB states followed by one or more ES states followed by one or more OL states followed by one or more ELF states. Because the portion of the state pattern identified at 1802 (a contiguous subset of all states associated with the scenario) matches that state search criteria 1804, the corresponding scenario data structure would be returned as an identified scenario.

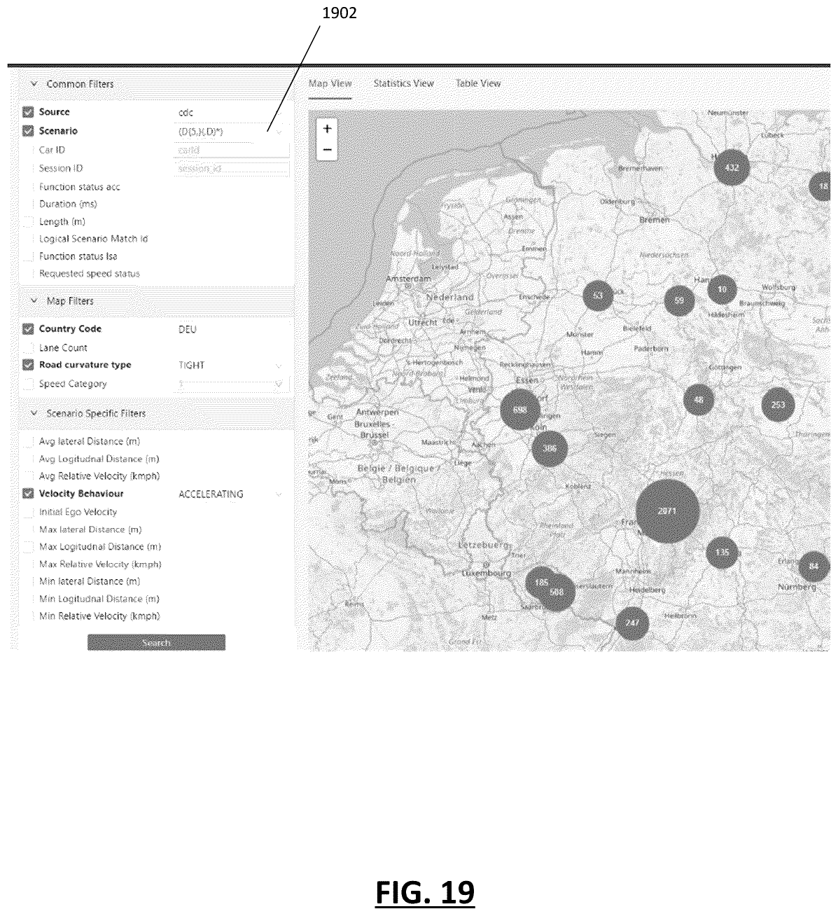

FIG. 19 is a diagram depicting a graphical user interface for identifying the state criteria of a query and additional non-state criteria. The user interface includes a control 1902 for specifying a state criteria, such as in a regular expression form. The user interface further includes controls for entering non-state search criteria including a source (e.g., a particular database containing scenario images), a particular car, a particular session, whether ACC was engaged, a scenario duration, a scenario distance, whether LSA was activated, a location (country) associated with the drive, a number of lanes on the road, a road curvature characteristics, a drive speed, a lateral distance between cars, a longitudinal difference between cars, relative velocity criteria, velocity trends, among others. The user interface includes a map indicating a number of scenarios associated with different locations, where clicking on a circle will set a location filter in the search criteria being defined.

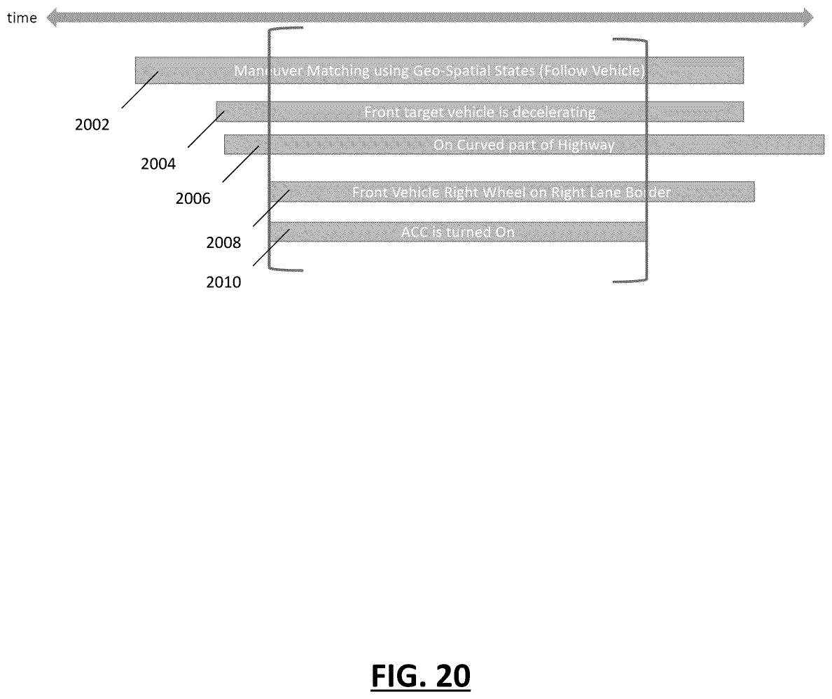

FIG. 20 is a diagram depicting a visualization of a search matching. As depicted in FIG. 20, a scenario search engine seeks to identify a portion of a scenario or a portion of a drive that matches all of the criteria, where the search criteria include state criteria 2002 and then a set of non-state criteria that include that the front target vehicle is decelerating 2004, the highway is curved 2006, the front vehicle has its right wheel on the right lane border 2008, and the adaptive cruise control is on 2010. The bars along the timeline indicate when those criteria are met within a scenario. Because there is a portion of the scenario in brackets that matches all of the criteria, the scenario data structure associated with that scenario is returned as indicating an identified scenario.

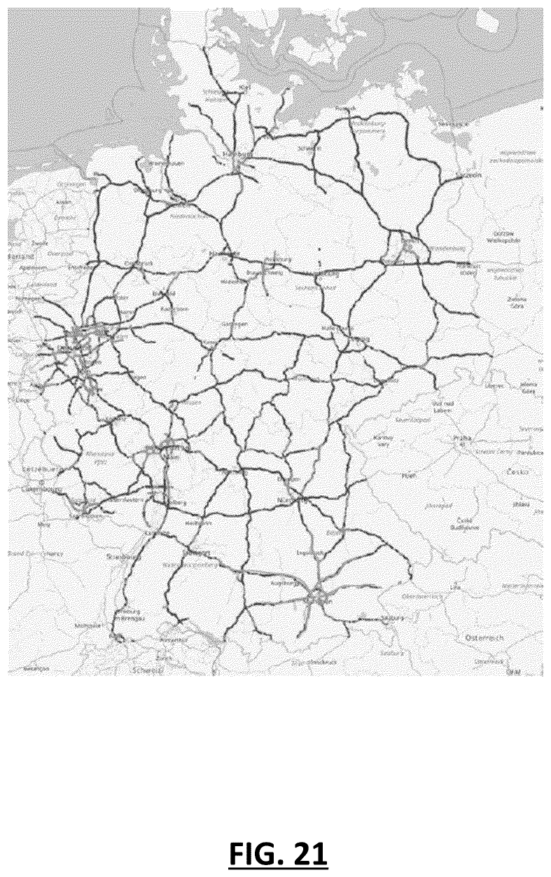

Scenario state identifications are typically classified offline (e.g., by a server after a drive is completed). Longer drives may be broken into scenarios, associated with scenario data structures, where sequences of states are then classified and other non-state data is determined for storage in the scenario data structures. Third party data sources may be used as part of that scenario data structure development process, as discussed above. For efficient processing, drives and their corresponding scenarios may be assigned for offline processing based on the location associated with those drives (e.g., a server with a local map database that matches the location of the drives assigned to that server). But drives tend to be clustered in concentrated areas, where many drives may be recorded in a particular city, with many fewer drives being recorded in a particular rural area. FIG. 21 depicts a map indicating a concentration of recorded drives in urban areas and areas where highways intersect.

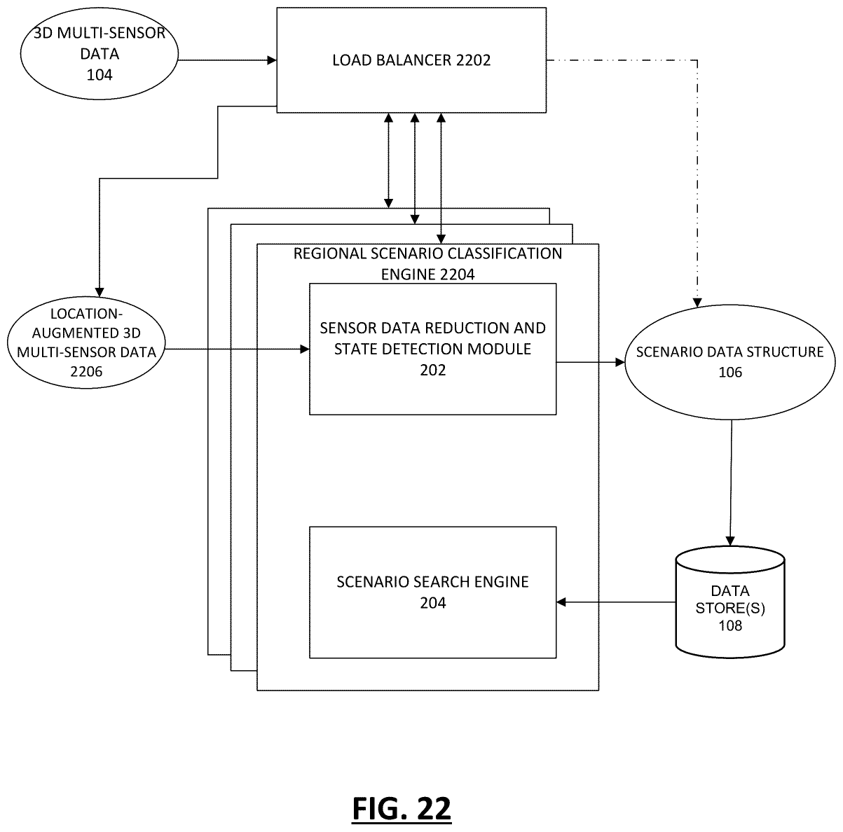

In some instances, the benefit provided by processing scenarios associated with a common geographic area by a single server is outweighed by bottlenecks caused by overwhelming those that server with scenarios. In such an instance, it may be worthwhile to have certain scenarios be processed by servers that are not associated with the location of the corresponding drive. FIG. 22 is a diagram depicting a load balancer for distributing scenarios for processing. A load balancer 2202 is in communication with a plurality of scenario classification engines 2204, such as those described herein, where each of those engines 2204 is associated with a particular region. The load balancer 2202 tracks the activity level of the engines 2204 (e.g., how many scenarios are waiting in engine queues, a current processing time for scenarios sent to different engines). Should that activity level indicate a bottle neck, the load balancer is configured to transmit scenarios and sensor data associated therewith to a different regional scenario classification engine 2204.

In one example, the load balancer 2202 is configured to accomplish this by “salting” the location associated with particular sets of sensor data 104. In such an example, the load balancer 2202 may add a random adjustment to the starting and/or ending location of a scenario drive, so as to associate that drive with another region. That scenario drive would then be routed to a different regional scenario classification engine 2204 for processing. The different regional scenario classification engine 2204 receives the location-augmented 3D multisensory data 2206 and provides sensor data reduction and state detection at 202 to populate a scenario data structure 106. For scenarios that have had their starting location augmented for load balancing reasons, at the conclusion of scenario data structure 106 generation, one of the scenario classification engine 2204 or the load balancer 2202 may adjust the starting location of the scenario drive so as to undo the adjustment made at 2206 for load balancing reasons. The sensor data structure 106 is then stored in a data store 108 and made available for subsequent search at 204.

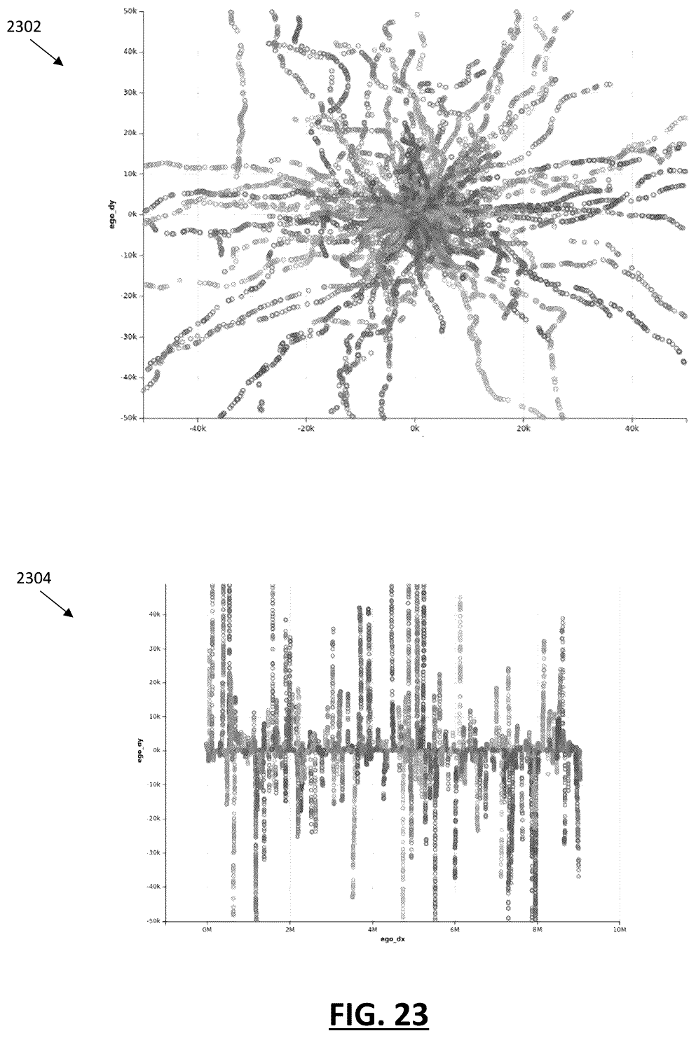

FIG. 23 is a diagram depicting augmenting scenario starting locations so as to perform load balancing. A graph at 2302 illustrates a large number of drives occurring at a concentrated area of geography. Overlapping drives may overburden a server associated with that geographic area. At 2304, starting and ending points of drives are augmented so as to substantially eliminarte overlap. The drives are then routed to a greater number of regional scenario classification engine servers, reducing the bottlenecks. The adjustments to drive locations may be undone at the conclusion of state classification and scenario data structure population.

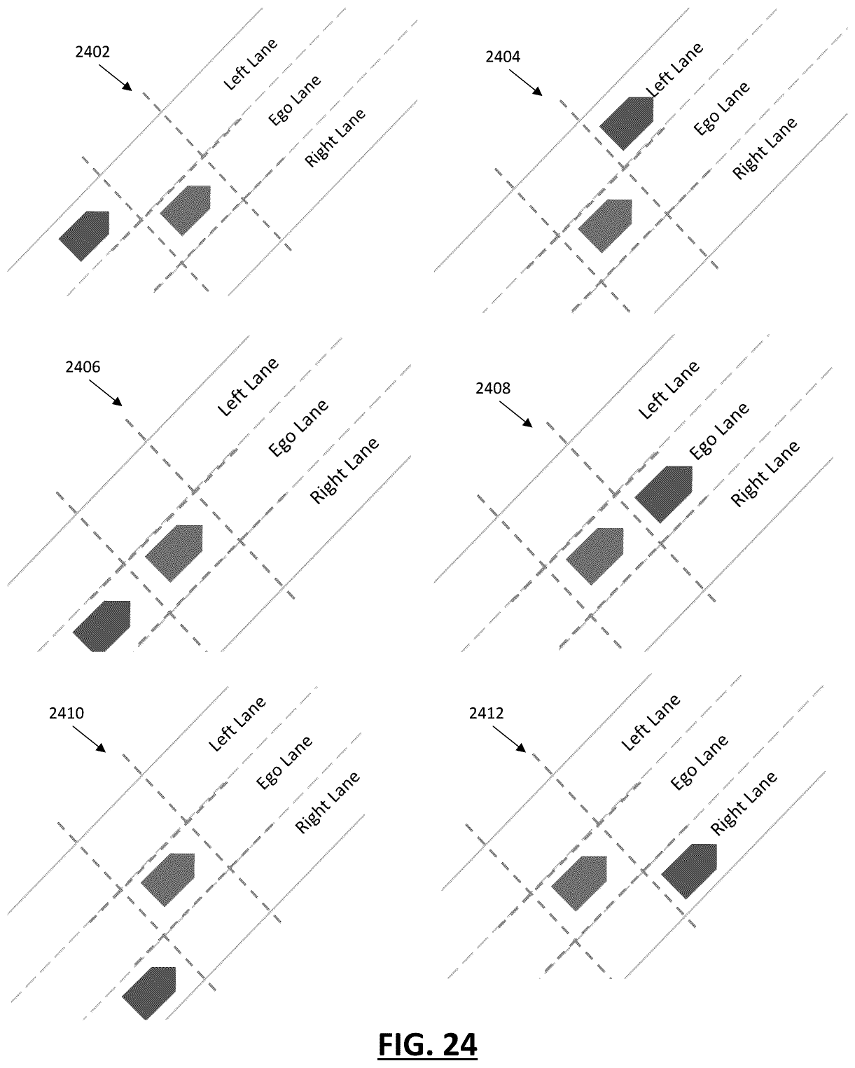

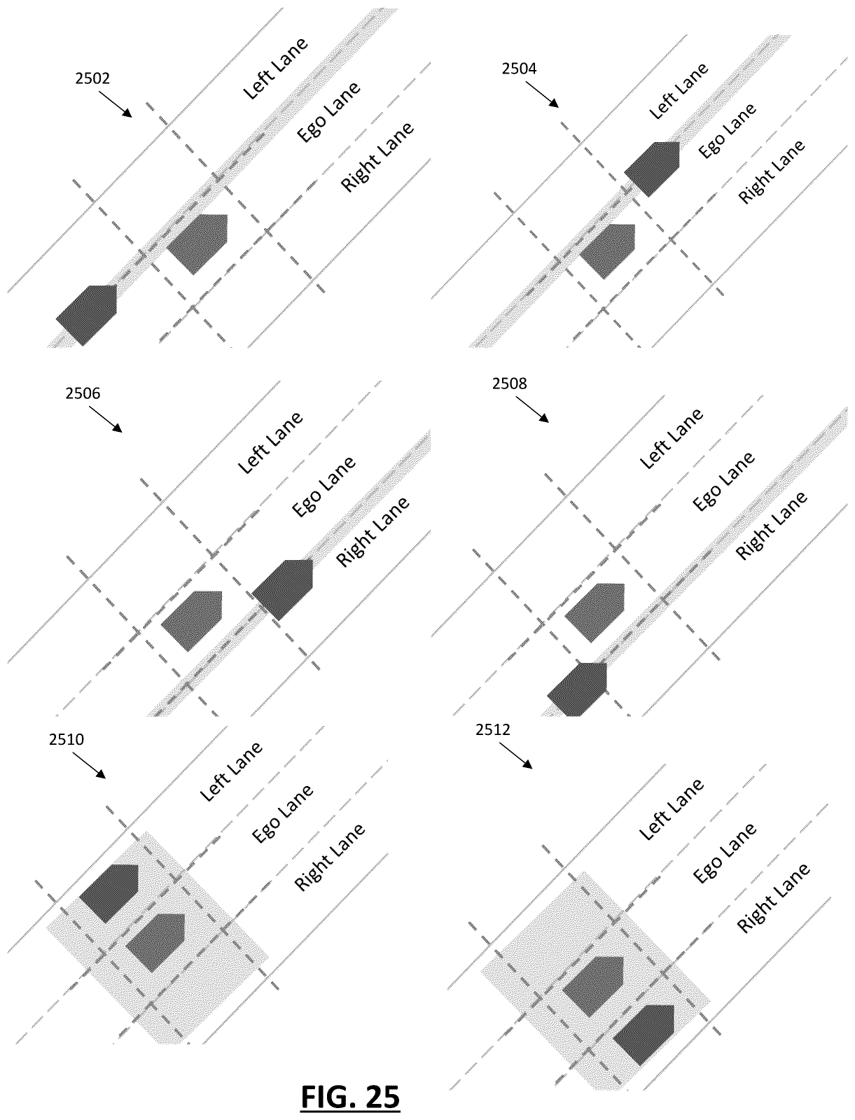

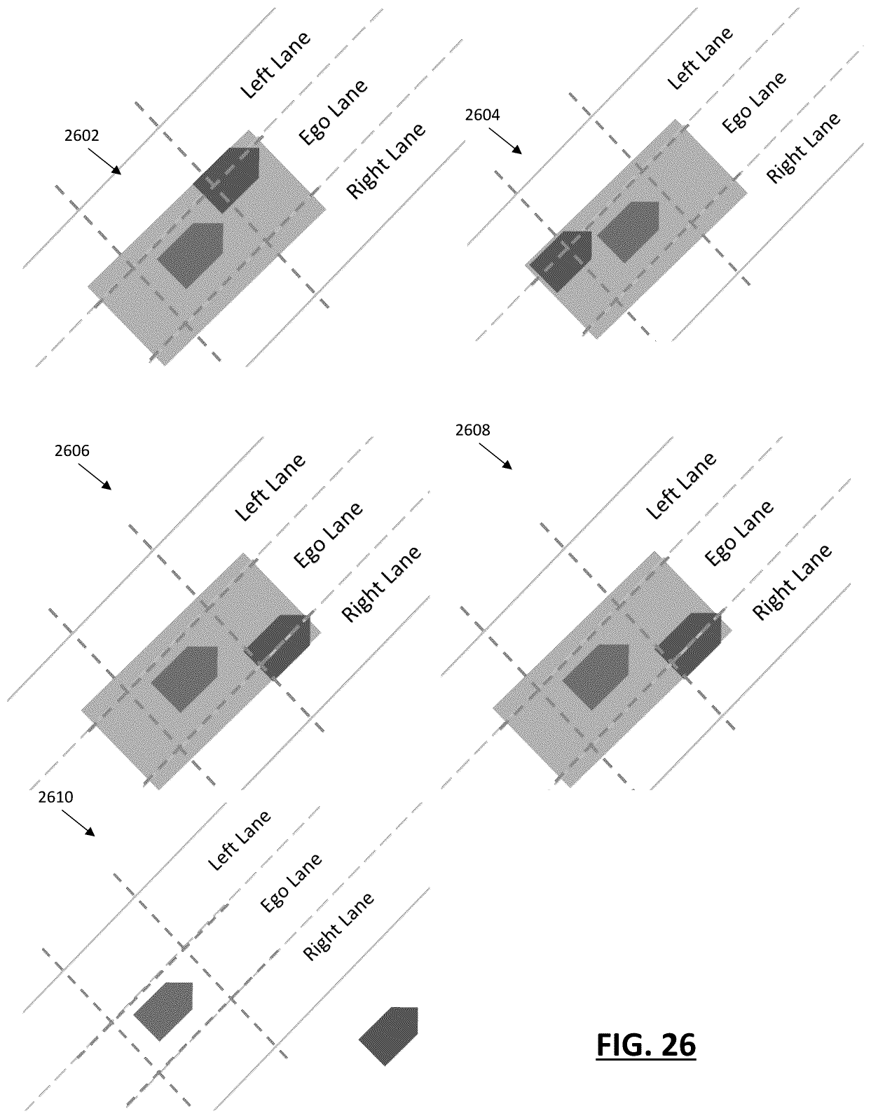

FIGS. 24-26 depict example scenario states that may be present in a sequence of states tracked by a scenario data structure. A left lane back state is depicted at 2402. A left lane front state is depicted at 2404. An ego lane back state is depicted at 2406, and an ego lane front state is shown at 2408. A right lane back state is shown at 2410, and a right lane front state is shown at 2412. An on left lane border back state is shown at 2502, while an on left lane border front state is shown at 2504. An on right lane border back state is shown at 2506, while an on right lane border front state is shown at 2506. A left lane on side state is shown at 2510, and a right lane on side state is illustrated at 2512. A left intrusion front is shown at 2602, and a left intrusion back state at 2604. A right intrusion front state is depicted at 2606, and a right intrusion back state is shown at 2608. A not in frame state is illustrated at 2610.

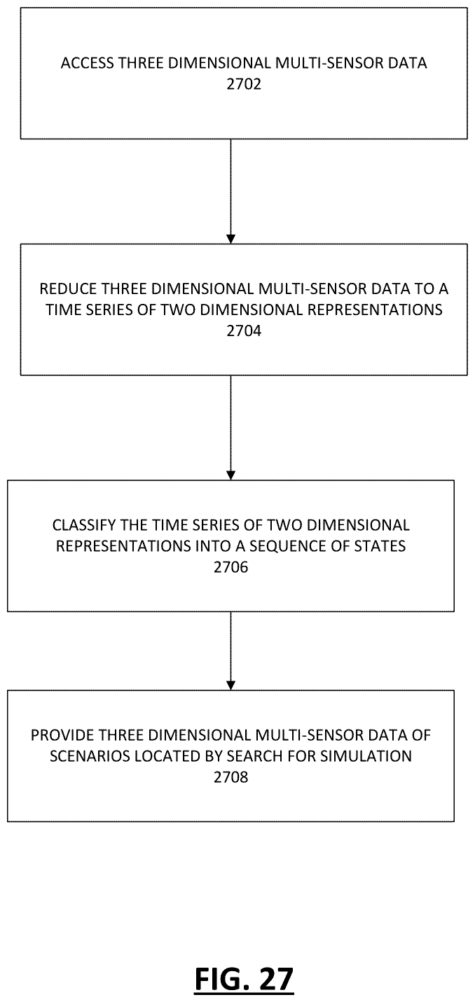

FIG. 27 is a flow diagram depicting for simulating operation of an autonomous vehicle control system. Three dimensional multi-sensor data associated with a plurality of real-world drives in a sensor equipped vehicle is accessed at 2702. For a particular drive, the three dimensional multi-sensor data is reduced to a time series of two dimensional representations at 2704. The time series of two dimensional representations is classified into a sequence of states at 2708, where the sequence of states associated with the particular drive and the three dimensional multi-sensor data are stored in a computer-readable medium as a scenario. At 2710, a query is received that identifies a state criteria, and the scenario is accessed based on the sequence of states matching the state criteria of the query. The three dimensional multi-sensor data of the scenario is provided to an autonomous driving system to simulate behavior of the autonomous driving system when faced with the scenario.

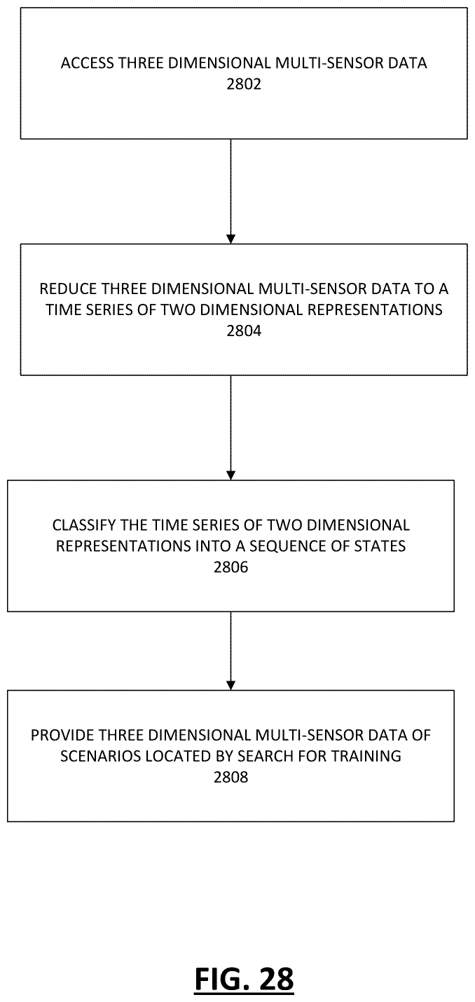

FIG. 28 is a flow diagram depicting a method of training an autonomous vehicle control system model. At 2802, three dimensional multi-sensor data associated with a plurality of real-world drives in a sensor equipped vehicle is accessed. For a particular drive, the three dimensional multi-sensor data is reduced at 2804 to a time series of two dimensional representations. The time series of two dimensional representations is classified into a sequence of states at 2806, where the sequence of states associated with the particular drive and the three dimensional multi-sensor data are stored in a computer-readable medium as a scenario. At 2810, a query is received that identifies a state criteria, and the scenario is accessed based on the sequence of states matching the state criteria of the query. The three dimensional multi-sensor data of the scenario is provided to an autonomous driving system to train an artificial intelligence model of the autonomous driving system, where three dimensional multi-sensor data of other scenarios that match the state criteria of the query are also provided to the autonomous driving system for training.

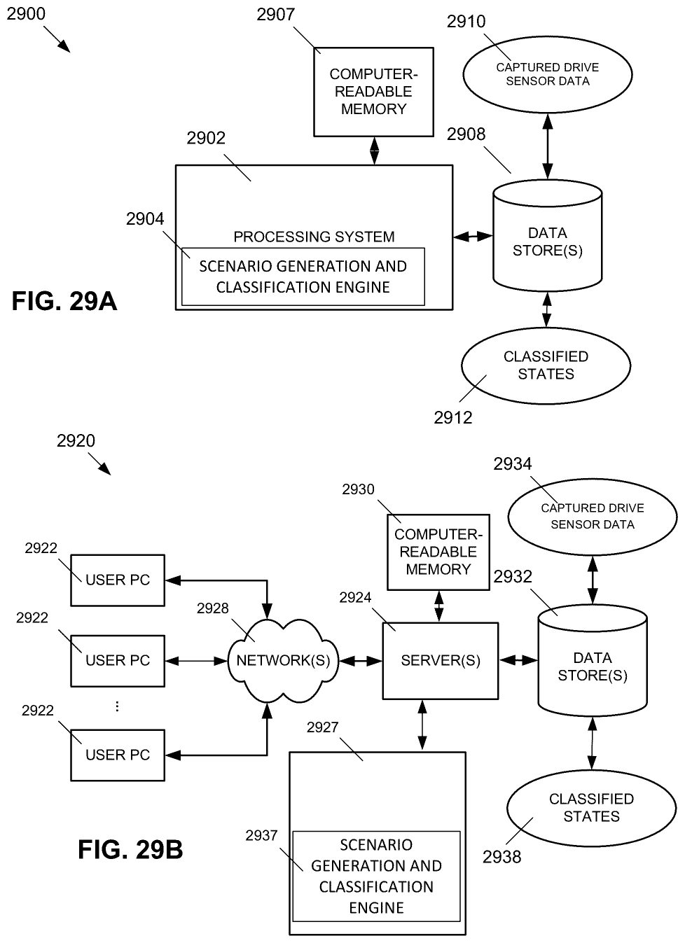

FIGS. 29A, 29B, and 29C depict example systems for implementing the approaches described herein for simulating operation of an autonomous vehicle control sensor. For example, FIG. 29A depicts an exemplary system 2900 that includes a standalone computer architecture where a processing system 2902 (e.g., one or more computer processors located in a given computer or in multiple computers that may be separate and distinct from one another) includes a computer-implemented scenario generation and classification engine 2904 being executed on the processing system 2902. The processing system 2902 has access to a computer-readable memory 2907 in addition to one or more data stores 2908. The one or more data stores 2908 may include captured drive sensor data 2910 as well as classified states 2912. The processing system 2902 may be a distributed parallel computing environment, which may be used to handle very large-scale data sets.

FIG. 29B depicts a system 2920 that includes a client-server architecture. One or more user PCs 2922 access one or more servers 2924 that include a scenario generation and classification engine 2937 operating on a processing system 2927 via one or more networks 2928. The one or more servers 2924 may access a computer-readable memory 2930 as well as one or more data stores 2932. The one or more data stores 2932 may include captured drive sensor data 2934 as well as classified states 2938.

FIG. 29C shows a block diagram of exemplary hardware for a standalone computer architecture 2950, such as the architecture depicted in FIG. 29A that may be used to include and/or implement the program instructions of system embodiments of the present disclosure. A bus 2952 may serve as the information highway interconnecting the other illustrated components of the hardware. A processing system 2954 labeled CPU (central processing unit) (e.g., one or more computer processors at a given computer or at multiple computers), may perform calculations and logic operations required to execute a program. A non-transitory processor-readable storage medium, such as read only memory (ROM) 2958 and random access memory (RAM) 2959, may be in communication with the processing system 2954 and may include one or more programming instructions for generating classifying scenario states. Optionally, program instructions may be stored on a non-transitory computer-readable storage medium such as a magnetic disk, optical disk, recordable memory device, flash memory, or other physical storage medium.

In FIGS. 29A, 29B, and 29C, computer readable memories 2907, 2930, 2958, 2959 or data stores 2908, 2932, 2983, 2984, 2988 may include one or more data structures for storing and associating various data used in the example systems. For example, a data structure stored in any of the aforementioned locations may be used to store data from XML files, initial parameters, and/or data for other variables described herein. A disk controller 2990 interfaces one or more optional disk drives to the system bus 2952. These disk drives may be external or internal floppy disk drives such as 2983, external or internal CD-ROM, CD-R, CD-RW or DVD drives such as 2984, or external or internal hard drives 2985. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 2990, the ROM 2958 and/or the RAM 2959. The processor 2954 may access one or more components as required.

A display interface 2987 may permit information from the bus 2952 to be displayed on a display 2980 in audio, graphic, or alphanumeric format. Communication with external devices may optionally occur using various communication ports 2982.

In addition to these computer-type components, the hardware may also include data input devices, such as a keyboard 2979, or other input device 2981, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents. It is claimed:

1. A method of simulating operation of an autonomous driving system, comprising:
accessing three dimensional multi-sensor data associated with a plurality of real-world drives in a sensor equipped vehicle;
for a particular drive, reducing the three dimensional multi-sensor data to a time series of two dimensional representations;
classifying the time series of two dimensional representations into a sequence of states, wherein the sequence of states associated with the particular drive and the three dimensional multi-sensor data are stored in a computer-readable medium as a scenario;
receiving a query that identifies a state criteria;
accessing the scenario based on the sequence of states matching the state criteria of the query;
providing the three dimensional multi-sensor data of the scenario to an autonomous driving system to simulate behavior of the autonomous driving system when faced with the scenario.

2. The method of claim 1, wherein a two dimensional representation identifies a position of one or more objects relative to the sensor equipped vehicle, wherein the objects include one or more other vehicles, an obstacle, a road sign, a road marking, a stop light, a person, or an animal.

3. The method of claim 1, wherein a particular state of the sequence of states is determined based on a prior state in the sequence of states.

4. The method of claim 3, wherein the particular state is selected from a subset of all possible states, wherein the subset is determined based on the prior state.

5. The method of claim 4, wherein the subset excludes impossible or unlikely states based on the prior state.

6. The method of claim 3, wherein the particular state is determined based on detection that a vehicle has intersected with a line painted on a road.

7. The method of claim 1, wherein the query further specifies an additional non-state criteria for scenario selection.

8. The method of claim 7, wherein the non-state criteria comprises one or more of a location, a vehicle velocity, a vehicle acceleration, a vehicle velocity pattern, a vehicle velocity trend, a traffic level, a time of day, a length of time, a weather condition, an event indication, a feature active indicator, a lane steering assistance active indicator, an adaptive cruise control indicator, an autonomous driving system active indicator, and a road curvature specification.

9. The method of claim 1, wherein the sequence of states is stored in the computer-readable medium as a text-based series of state indicators that is searchable via regular expression search criteria.

10. The method of claim 1, wherein reducing the three dimensional data comprises consolidating a plurality of points into a location of an object on a two dimensional plane.

11. The method of claim 10, wherein reducing the three dimensional data comprises:
identifying missing data associated with one sensor in the three dimensional multi-sensor data; and
using interpolation to determine replacement data for the missing data using data from another sensor in the multi-sensor data or another data source;
wherein the location of the object is determined using the replacement data.

12. The method of claim 11, wherein the another data source is a location of the object at a prior time.

13. The method of claim 1, wherein the real-world drives are each associated with a location;
wherein said reducing and classifying are performed using a server that is assigned real-world drives based on the location associated with those real-world drives;
wherein a location associated with a particular real-world drive is temporarily adjusted to avoid overloading over the server.

14. The method of claim 13, wherein adjusting the location comprises adjusting a starting point of the particular real-world drive.

15. The method of claim 1, wherein behavior of the autonomous driving system is approved or rejected based on the simulation.

16. The method of claim 1, wherein the scenario is accessed based on a contiguous subset of all states associated with the scenario matching the state criteria.

17. The method of claim 1, further comprising providing a graphical user interface for identifying the state criteria of the query and one or more additional criteria; and
receiving the state criteria and the one or more additional criteria via the user interface;
wherein the scenario is accessed based on the sequence of states matching the state criteria and the scenario matching the one or more additional criteria received via the user interface.

18. A method of training an autonomous driving system model, comprising:
accessing three dimensional multi-sensor data associated with a plurality of real-world drives in a sensor equipped vehicle;
for a particular drive, reducing the three dimensional multi-sensor data to a time series of two dimensional representations;
classifying the time series of two dimensional representations into a sequence of states, wherein the sequence of states associated with the particular drive and the three dimensional multi-sensor data are stored in a computer-readable medium as a scenario;
receiving a query that identifies a state criteria;
accessing the scenario based on the sequence of states matching the state criteria of the query;
providing the three dimensional multi-sensor data of the scenario to an autonomous driving system to train an artificial intelligence model of the autonomous driving system, wherein three dimensional multi-sensor data of other scenarios that match the state criteria of the query are also provided to the autonomous driving system for training.

19. The method of claim 18, wherein a particular state of the sequence of states is determined based on a prior state in the sequence of states.

20. The method of claim 19, wherein the particular state is selected from a subset of all possible states, wherein the subset is determined based on the prior state, wherein the subset excludes impossible or unlikely states based on the prior state.
